(19) United States
(12) Patent Application Publication
(10) Pub. No.: US 2024/0149148 A1
(43) Pub. Date: May 9, 2024

(54) Game Controller with Play-on-Any-Screen Feature

(71) Applicant: Backbone Labs, Inc., Vancouver, WA (US)

(72) Inventors: Shawn O'Connor, Portland, OR (US); Maneet Khaira, Vancouver, WA (US); Andrew Sibert, Santa Cruz, CA (US)

(73) Assignee: Backbone Labs, Inc., Vancouver, WA (US)

(21) Appl. No.: 18/214,917

(22) Filed: Jun. 27, 2023

Related U.S. Application Data
(60) Provisional application No. 63/422,797, filed on Nov. 4, 2022.

(51) Int. Cl. A63F 13/22; A63F 13/92

(52) U.S. Cl. CPC A63F 13/22; A63F 13/92

(57) ABSTRACT

Attaching a mobile game controller to a computing device brings to life an entirely new gaming player device and gaming environment. A combination of a user input device, platform operating service, cloud service, screen, and mobile operating system allows the system to take advantage of a plethora of synergies and offers entirely new experiences. The embodiments described herein can provide a sophisticated and highly-extensible gaming experience that is vastly more than the sum of the parts.

### CROSS-REFERENCE TO RELATED APPLICATION

This application claims the benefit of U.S. Provisional Patent Application No. 63/422,797, filed Nov. 4, 2022, which is hereby incorporated by reference.

### BACKGROUND

A game controller is a device used to provide input to a video game, for example, to control an object or character in the video game. The video game may be running on a computer, a specially-designated gaming system, or a mobile device. In some prior art devices, the game controller is designed to mechanically couple to a mobile device.

### BRIEF DESCRIPTION OF THE DRAWINGS

FIG. 1 is a top, perspective view showing portions of a game controller of an embodiment

FIG. 2 is a top, perspective view of the game controller of FIG. 1.

FIG. 3 is a top, perspective view of the game controller of FIG. 1.

FIG. 4 is a partially exploded view of the game controller of FIG. 3.

FIG. 5 is a bottom, perspective view of the game controller of FIG. 3.

FIG. 6 is a perspective view of a game controller of an embodiment.

FIG. 7 is a top view of the game controller of FIG. 6.

FIG. 8 is an illustration of an integrated game controller of an embodiment.

FIG. 9 is an illustration of an example environment for a game controller of an embodiment.

FIG. 10 is an illustration of a cloud service of an embodiment.

FIG. 11 is an illustration of subsystems of an embodiment.

FIG. 12 is an illustration of a mobile game controller and mobile device of an embodiment.

FIG. 13 is a flowchart of an example upgrade procedure of an embodiment.

FIG. 14 is an illustration of a game controller of an embodiment with primary and secondary ports.

FIG. 15 is a diagram of a configuration flow of an embodiment.

FIG. 16 is a screen shot of a settings menu of an embodiment.

FIG. 17 is a screen shot of a selection menu for a Play on Any Screen feature of an embodiment.

FIG. 18 is an illustration of a demonstration of a Play on Any Screen feature of an embodiment.

FIG. 19 is a block diagram of a mobile game controller, a mobile device, and a USB host of an embodiment.

FIG. 20 is a screen shot of a capture, edit, and share feature of an embodiment.

FIG. 21 is a screen shot of an embodiment for recording.

FIG. 22 is a screen shot of an embodiment for streaming.

FIG. 23 is a block diagram of a mobile game controller and a platform operating service of an embodiment.

FIG. 24 is a screen shot of an embodiment for choosing a recording mode.

FIG. 25 is a screen shot of an embodiment displaying a notification that smart recording is enabled.

FIG. 26 is a block diagram of an audio/video pipeline of an embodiment.

FIG. 27 is an illustration of a mobile phone and mobile game controller of an embodiment.

FIGS. 28-29 are screen shots that illustrate a live streaming feature of an embodiment.

FIGS. 30-31 are screen shots that illustrates an account linking feature of an embodiment.

FIGS. 32-37 are screen shots that illustrate a capture gallery feature of an embodiment.

FIG. 38 is a screen shot that illustrates a watermarking feature of an embodiment.

FIGS. 39-41 are screen shots that illustrate a video editor feature of an embodiment.

FIGS. 42-43 are screen shots that illustrate a game tagging feature of an embodiment.

FIG. 44 is an illustration of a controller input architecture of an embodiment.

FIG. 45 is an illustration of buttons of a controller of an embodiment.

FIG. 46 is an illustration of a button descriptor of an embodiment.

FIG. 47 is an illustration of an integrated dashboard of an embodiment.

FIG. 48 is an illustration of a content grid of an embodiment.

FIG. 49 is an illustration of an app store badge of an embodiment.

FIG. 50 is a flow diagram of an integrated dash of an embodiment.

FIG. 51 is an illustration of a content grid of an embodiment.

FIG. 52 is a content page flow diagram of an embodiment.

FIG. 53 is an illustration of a general client-server architecture of an embodiment.

FIG. 54 is a flow diagram illustrating application/service games database interaction of an embodiment.

FIG. 55 is an illustration of a system of architecture of an embodiment.

FIG. 56 is a flow diagram of an application integrated dashboard of an embodiment.

FIG. 57-59 are screen shots that show examples of personalized content of an embodiment.

FIG. 60 is a flow diagram of an embodiment.

FIG. 61 is a screen shot of an embodiment showing an example of recently-played games.

FIG. 62 is a screen shot that illustrates this embodiment.

FIGS. 63-64 are screen shots of an embodiment for launching a browser.

FIGS. 65-66 are screen shots of example implementations of a browser rendering an external gameplay service of an embodiment.

FIG. 67 is a screen shot of an exit screen of an embodiment.

FIG. 68 is a screen shot of an embodiment showing popular games.

FIGS. 69-70 are screen shots of an embodiment for searching content.

FIG. 71 is an illustration of a platform operating service and external gameplay service of an embodiment.

FIG. 72 is a notification flow diagram of an embodiment.

FIG. 73 is a screen shot of a Friends that Play feature of an embodiment.

FIG. 74 is a screen shot of an example game search view of an embodiment.

FIGS. 75-76 are screen shots of welcome screens of an embodiment.

FIG. 77 is a screen shot of an embodiment for user name input.

FIG. 78 is a screen shot of an embodiment that informs a user that a console is not required.

FIGS. 79-83 are screen shots of an embodiment for educating a user and prompting the user to purchase or subscribe.

FIGS. 84-86 are screen shots of an embodiment.

FIG. 87 is a screen shot showing a notification of an embodiment.

FIG. 88 is a flow diagram of an embodiment.

FIG. 89 is a screen shot of an embodiment showing an example of human readable presence indicator.

### DETAILED DESCRIPTION

Features, aspects, and advantages of the presently-disclosed technology may be better understood with regard to the following description and accompanying drawings (including actual screenshots). The drawings are for the purpose of illustrating example embodiments, but it is understood that the embodiments are not limited to the arrangements and instrumentality shown in the drawings. Additionally, here are some terms that may be used in the description below, in addition to illustrative examples for each term in accordance with certain embodiments. It will be understood by one of ordinary skill in the art that each term might comprise numerous other and/or different examples:

Mobile game controller: A physical device which captures user inputs and interacts with a computing device to allow the user to play a video game.

Computing device: Smartphone, tablet, etc.

Gameplay device: The combination of a mobile game controller with a computing device or all-in-one computing device.

Embedded software: Software running on the mobile game controller.

Platform Operating Service: Software app (one or more) and cloud service (one or more).

Smart mobile game controller: The combination of a mobile game controller, computing device, embedded software, and platform operating service.

It is understood that the description discloses, among other things, various example systems, methods, apparatus, and articles of manufacture including, among other components, firmware and/or software executed on hardware. It is also understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The description is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments.

When any embodiments are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

Attaching a mobile game controller to a computing device brings to life an entirely new gaming player device and gaming environment. A combination of a user input device, platform operating service, cloud service, screen, and mobile operating system allows the system to take advantage of a plethora of synergies and offers entirely new experiences. The embodiments described herein can provide a sophisticated and highly-extensible gaming experience that is vastly more than the sum of the parts.

While not every component would be, or necessarily need to be, used in every configuration, the components of the system(s) may include:

1. A Mobile Game Controller

The mobile game controller is an input device designed to primarily be used with a computing device, typically with input surfaces on either side of the computing device. The mobile game controller can be connected via a wired or wireless connection to the computing device. In certain embodiments, the mobile game controller might also output signals, such as haptic feedback, visual, audible signals, or some combination thereof. While the embodiments described herein are not so limited unless otherwise stated, an example of a mobile game controller is the Backbone One, offered by Backbone (www.playbackbone.com).

One example type of a mobile game controller is described in the U.S. patent application Ser. No. 17/504,283, filed Oct. 18, 2021 entitled “Game Controller for a Mobile Device with Flat Flex Connector,” which is a continuation-in-part application of U.S. patent application Ser. No. 16/808,339, filed Mar. 3, 2020, both of which are incorporated into the present disclosure by reference. The following are also hereby incorporated by reference: (a) U.S. patent application Ser. No. 17/866,166, filed Jul. 15, 2022, entitled “Game Controller for a Mobile Device with Flat Flex Connector;” (b) U.S. patent application Ser. No. 17/866,234, filed Jul. 15, 2022, entitled “Game Controller for a Mobile Device with Extended Bumper Button;” (c) U.S. patent application Ser. No. 17/856,895, filed Jul. 15, 2022, entitled “Game Controller with Magnetic Wireless Connector;” and (d) U.S. patent application Ser. No. 17/850,912, filed Jul. 15, 2022, entitled “Game Controller for a Mobile Device.”

It is also understood that a mobile game controller, in some embodiments, might be less mobile or substantially fixed or stationary, depending on the desired use or application of the mobile game controller. Additional embodiments of mobile game controllers can be as follows.

An external controller can be connected to a television or other computing devices. In certain embodiments, the mobile game controller can have a “pass-through charging port,” which enables electrical power to be transferred to a computing device during gameplay. As battery life can have a large impact on usage and retention, this feature can allow users to continue playing longer without running out of charge. In some cases, if the controller is wireless, the pass-through charging port can also, either by default or by configuration, charge the controller as well. The secondary port designed for multi-use is positioned in a way that does not interfere with the hands during gameplay.

In certain embodiments, the mobile game controller has one or more software service buttons which, when selected, can perform in-app functions or functions through an platform operating system API as opposed to providing the inputs solely via the standard input device framework provided from the device operating system meant for standard game controller inputs (e.g., ABXY, L1/R1, L2/R2, D-Pad, Joysticks, Start, Select). (Start and Select are also sometimes known as Menu and Options.) In some embodiments, a software service button is a physical button of an electrical circuit that can be depressed by a user. In other embodiments, a software service button is a capacitive touch or other kind of soft button.

A software service button may also send inputs via the mobile operating system's input device framework based on user context. For example, in some embodiments, the behavior of the software service button can change depending on whether the current application is in the foreground or background. For example, when the user is playing the game inside a web browser within the platform operating service, the software service button behavior changes based on context. For example, while streaming a game inside the Amazon Luna service, pressing the software service button can now send a Human Interface Device (HID) command that opens up the Amazon Luna menu by triggering the “Start” button or invoke the cloud gaming service's own capture functionality.

Note that in certain embodiments, a software service button can be another type of input besides a button, such as a switch or thumbstick. In other embodiments, a software service button is a combination of two or more inputs that the platform operating service interprets as a single signal to perform the aforementioned functions.

2. A Computing Device

A primary computing device is a computing device that can be connected via the main interface of the mobile game controller (e.g., a Lightning plug, USB-C plug, or via Bluetooth). In certain embodiments, the primary computing device is the main type of device that the mobile game controller is designed to be used with. In some embodiments, examples of computing devices include an iPhone™, an Android phone, or tablet computer (“tablet”).

In certain embodiments, the primary computing device can be a general-purpose computing device, like a mobile smartphone, which can often offer functionality like productivity tools, telephony, messaging, wireless communication (e.g., phone calls, etc.). Thus, in this case, the mobile game controller system transforms a user's general-purpose computing device into a gaming-centric device. In certain embodiments, the primary computing device and mobile game controller can be physically fused into one device for the end user. A secondary computing device is a computing device that is connected via a secondary port, either wired or wireless, on the mobile game controller, which is not the primary computing device the mobile device was designed for.

3. Device Operating System

The device operating system has a framework or API interface that enables gaming input hardware devices to interact with applications running on the device operating system of a computing device. Examples include Android, iOS, and webOS.

4. Content

Content can refer to any form of media where a user can install, view, play, edit, store, and share. Applications that enable a user to access content can itself be considered content. Games are a form of content either installed or streamed. Examples include Amazon Luna Games, Remote Play, Roblox, Minecraft, Marvel Snap, etc.

5. Platform Operating Service

The platform operating service comprises one or more applications (apps) that can run on computing device(s) and one or more services. The platform operating service can be part of the device operating system (first-party with respect to the device operating system) or be third-party with respect to the device operating system. Further, the platform operating service can also include features of the device operating system. For example, if the device operating system were to offer a certain functionality described below, the platform operating service could include that functionality.

Examples might include, but are not limited to, a combination of the game controller app, APIs natively on the computing device, interfaces within the device operating system, and various backend services hosted both internally and externally. Further, the platform operating service application can comprise any user interface presented on the computing device. For example, a popup prompt describing the benefits of the platform operating service that is surfaced by the device operating system would also be considered a part of the platform operating service application. A website displayed on the computing device that enables the user to view and launch content would also be considered part of the platform operating service application. The platform operating system can interface with hardware features of the mobile game controller.

The platform operating service can interact with one or more software service buttons. The software service buttons can be used to perform application functions. In some embodiments, the software service button can be used to load the application into the foreground view of the device operating system stack. The platform operating service can also interact with one or more software service indicators. Software service indicators are physical affordances on the mobile game controller such as status lights that the platform operating service can activate. For example, when a device is connected, a software service indicator on the mobile game controller might pulse white.

In certain embodiments, the platform operating service provides the following features. The platform operating service application can be launched with the software service button and the user can navigate the interface with the inputs on the device.

The platform operating service application can invoke additional software-enabled functionality including the “play on any screen” function (allows the user to reconfigure the multi-use port to have other functionality via the integrated application), live streaming, screen sharing, flashback recording, and more.

The integrated application can contain a search function which allows the user to query a database of content across multiple services (e.g., remote play, cloud gaming, or native applications). In certain embodiments, when a user launches the platform operating service application, they can use the controller to search for compatible games across the platform operating service. The user can either launch into or download them.

The integrated application can also allow users to connect their accounts from external services including, but not limited to, Xbox Cloud Gaming, Steam, Netflix, and Apple Arcade. For instance, based on recent history of gameplay, the platform operating service application can then insert those games into the compatible games list within their library or otherwise adjust the Integrated Dashboard content. Users can then use the software service button to open directly into a dashboard of their compatible games across multiple external services. Further, this allows the platform operating service's cloud service to provide enhanced suggestions to users based on a multitude of inputs such as device state, user account information, platform preferences, and more.

The content suggestions in the platform operating service application can be based on the product SKU properties of the device. For example, if the user's smart mobile game controller device is tailored for a particular service, e.g. PS Remote Play, then when the platform operating service application renders Integrated Dashboard it can provide a response that prioritizes PlayStation content.

The platform operating service application can reconfigure its button icon language based on the symbology used on the mobile game controller. E.g. if a mobile game controller with an ABXY button layout is detected vs. a game controller with an ABCD button layout, the interface can automatically detect the SKU and replace the button hints inside of the interface.

Mobile apps are typically based in portrait mode (designed to be consumed in the format where the computing device is held so that the longer edge is vertical) and are designed to be used primarily with touch interfaces. In certain embodiments, when the mobile game controller is attached to the computing device, the platform operating service application can adjust the screen orientation into an alternate orientation, such as landscape, on the screen, and the interface can accept the mobile game controller inputs as the primary input modality.

The interface of the platform operating service application can be navigated using game controller inputs. In some embodiments, button hints are shown to illustrate what controls correspond to which actions on the screen. The interface may also accept touch controls. In certain embodiments, users may be able to launch into content without using the touch interface, using only controls on the mobile game controller. In some embodiments, a device operating system can have native features (e.g. landscape mode, controller support) that can be used by a mobile game controller. In this case, it is still part of the platform operating service. In certain embodiments, it can be used by the software service button to interact with the features natively built into the device operating system.

6. Cloud Service

In certain embodiments, the platform operating service can comprise one or more cloud services, hosted on one or more server computers, to provide additional features, including suggestions and recommendations for compatible game or media content for the mobile game controller. The cloud service is not necessarily hosted in a cloud computing facility or service provider. In other embodiments, the cloud service can be hosted in a self-maintained data center or even on a computer on the user's local area network. Further, the cloud service can also comprise first and/or third-party services that stream games to the platform operating service over a network such that they can be consumed through the user interface of the platform operating service.

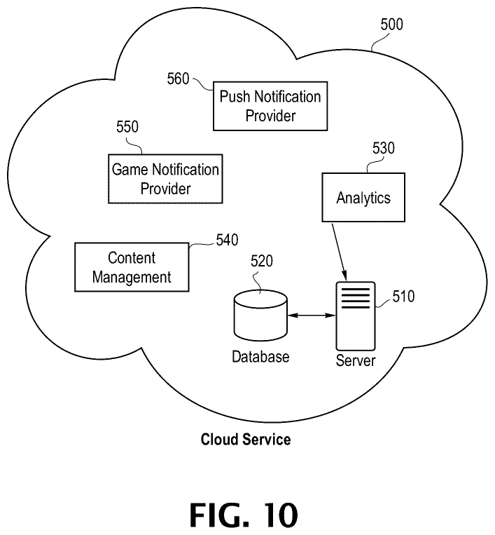

FIG. 10 is an illustration of a cloud service 500 of an embodiment. As shown in FIG. 10, the cloud service 500 of this embodiment comprises a server 510 connected with a database 520 and an analytics element 530. The cloud service 500 of this embodiment also comprises a content management element 540, a game notification provider 550, and a push notification provider 560.

Example Hardware

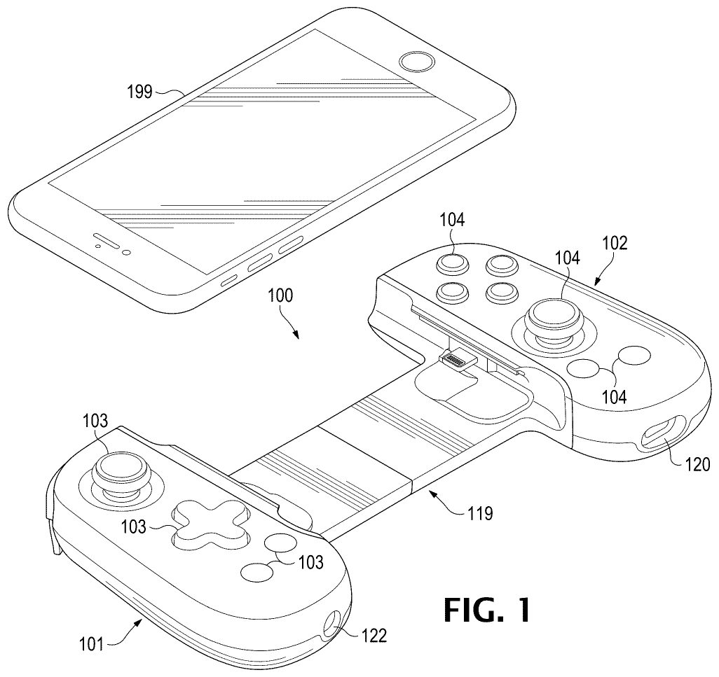

The following discussion refers to the drawings numbered FIGS. 1 to 9 that are provided with this disclosure. The three-digit numbers appearing in the text are reference numbers and refer to features in the drawings.

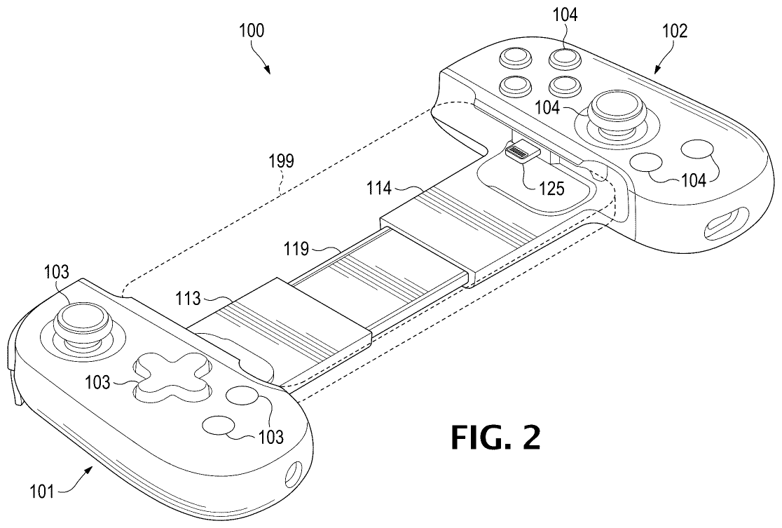

FIG. 1 is a top, perspective view showing portions of a game controller 100, according to embodiments, in an example of a retracted configuration of the game controller and illustrated next to an example mobile device 199. FIG. 2 is a top, perspective view of the game controller 100 of FIG. 1, illustrating how the game controller 100 may contact and support a mobile device 199 in some embodiments. As illustrated in FIGS. 1-2, the game controller 100 may include a first handle 101, a second handle 102, and a bridge 119. Each of the first handle 101 and the second handle 102 is configured to contact and support the mobile device 199, though not all contemplated embodiments will include the second handle 102.

In certain embodiments, “mobile device” generally refers to a portable, handheld computing device, such as a smartphone, tablet, or other comparable mobile device. The mobile device typically runs an operating system, including but not limited to iOS or Android.

As illustrated, the first handle 101 includes a user-accessible, first hardware interface 103. The first hardware interface 103 could be a button, an analog stick, a touchscreen, a touchpad, a knob, a slider, a switch, a wheel, a dial, a directional pad, or another such feature configured to accept touch inputs from a user's finger or a stylus. As shown in FIG. 1, the first hardware interface 103 may include multiple such hardware interfaces.

As illustrated, the second handle 102 further includes a user-accessible, second hardware interface 104. As above for the first hardware interface 103 of the first handle 101, the second hardware interface 104 could be a button, an analog stick, a touchscreen, a touchpad, a knob, a slider, a switch, a wheel, a dial, a directional pad, or another such feature configured to accept touch inputs from a user's finger or a stylus. The second hardware interface 104 may include multiple such hardware interfaces, as illustrated in FIG. 1.

In configurations, one or more of the buttons, etc. of the first hardware interface 103 or the second hardware interface 104 are the software service buttons discussed elsewhere in this disclosure.

One or both of the first handle 101 and the second handle 102 may include a connector 125 for physical and electrical connection to the mobile device 199. The connector 125 may be, for example, a USB-C connector. In addition, one or both of the first handle 101 and the second handle 102 may include a pass-through charging port 120 or a headphone jack 122, or both. The pass-through charging port 120, for example, allows the mobile device 199 to have its battery charged when the mobile device 199 is attached to the connector 125. The headphone jack 122 allows an audio signal generated by the game controller 100 or the mobile device 199, or both to be sent to an external headphone or other speaker.

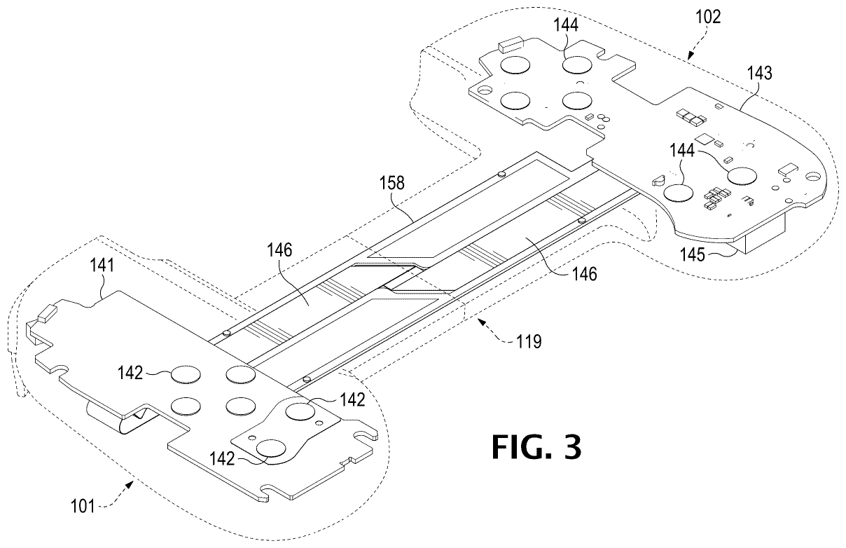

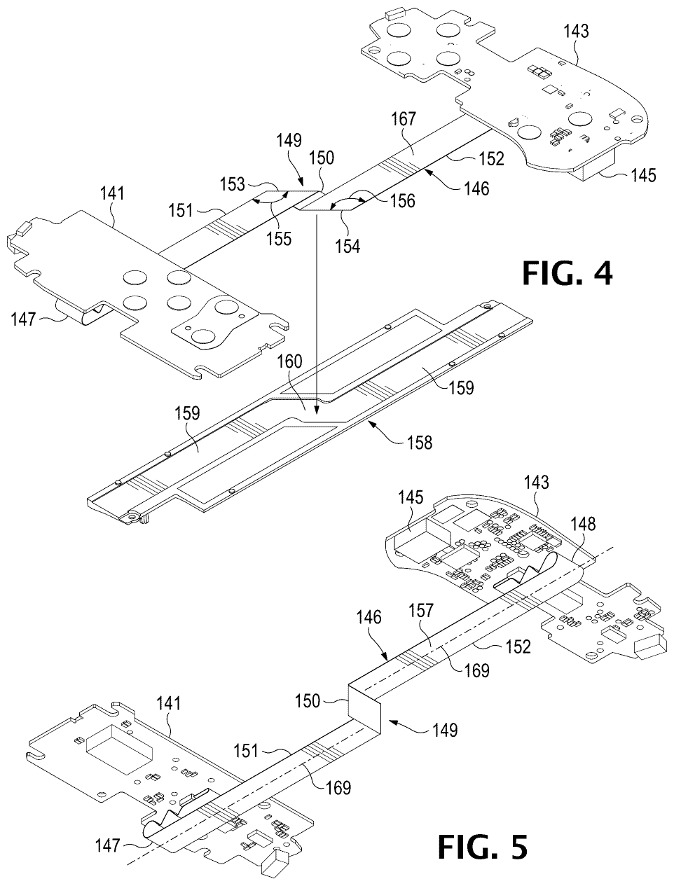

FIG. 3 is a top, perspective view of the game controller 100 of FIG. 1, showing only certain features internal to the game controller 100. FIG. 4 is a partially exploded view of the game controller 100 of FIG. 3. FIG. 5 is a bottom, perspective view of the game controller 100 of FIG. 3.

As illustrated in FIGS. 3-5, the first handle 101 includes a first electronic circuit 141 that is coupled to the first hardware interface 103. For example, as illustrated in FIG. 3, the first hardware interface 103 has a corresponding feature 142 of the first electronic circuit 141. The corresponding feature 142 of the first electronic circuit 141 is configured to translate a mechanical, touch input to the first hardware interface 103 into an electrical signal. Hence, for example, the corresponding feature 142 of the first electronic circuit 141 may be an electronic switch.

Likewise, the second handle 102 includes a second electronic circuit 143 that is coupled to the second hardware interface 104. For example, as illustrated in FIG. 3, the second hardware interface 104 has a corresponding feature 144 of the second electronic circuit 143. The corresponding feature 144 of the second electronic circuit 143 is configured to translate a mechanical, touch input the second hardware interface 104 into an electrical signal. Hence, for example, the corresponding feature 144 of the second electronic circuit 143 may be an electronic switch.

The second handle 102 further includes an electronic controller 145. The electronic controller 145 is configured to receive an electrical signal from the second electronic circuit 143. The electrical signal from the second electronic circuit 143 may be, for example, the electrical signal produced by the corresponding feature 144 of the second electronic circuit 143 in response to a touch input at the second hardware interface 104. The electronic controller 145 is also configured to receive an electrical signal from the first electronic circuit 141 via a flat, flexible cable 146. The electrical signal from the first electronic circuit 141 may be, for example, the electrical signal produced by the corresponding feature 142 of the first electronic circuit 141 in response to a touch input at the first hardware interface 103.

The flat, flexible cable 146 is configured to conduct an electrical signal between the first handle and the second handle. In configurations, the flat, flexible cable 146 is a flat and flexible plastic film base, with multiple, flat, metallic conductors bonded to one surface of the film base. As illustrated most clearly in FIG. 5, the flat, flexible cable 146 may be coupled at a first end 147 of the flat, flexible cable 146 to the first electronic circuit 141 and, at a second end 148 of the flat, flexible cable 146, to the second electronic circuit 143.

As illustrated most clearly in FIG. 4, in configurations the flat, flexible cable 146 includes a double fold 149. In configurations, the double fold 149 may be at the midline 121 of the bridge 119. In the illustrated configuration, the double fold 149 includes a folded section 150. Between the folded section 150 and a first elongated section 151 of the flat, flexible cable 146 is a first fold 153. And between the folded section 150 and a second elongated section 152 of the flat, flexible cable 146 is a second fold 154.

As illustrated, the fold angle 155 of the first fold 153 and the fold angle 156 of the second fold 154 are substantially equal and are less than 180°. As used in this context, “substantially equal” means largely or essentially equivalent, without requiring perfect identicalness. Accordingly, the first elongated section 151 of the flat, flexible cable 146 and the second elongated section 152 of the flat, flexible cable 146 are substantially parallel. As used in this context, “substantially parallel” means largely or essentially equidistant at all points (if the longitudinal centerline 169 of each elongated section were conceptually extended), without requiring perfect parallelism.

Consequently, the folded section 150 is at an angle to each of the first elongated section 151 and the second elongated section 152 as defined by the fold angles. Stated another way, before it is folded, the flat, flexible cable 146 has a longitudinal centerline 169 midway between its edges. Once folded, the longitudinal centerline 169 running through the first elongated section 151 and the longitudinal centerline 169 running through the folded section 150 are and an angle to each other, that angle being related to the fold angles.

In configurations, including in the illustrated configuration, the double fold 149 causes the same side 157 of the flat, flexible cable 146 to double over onto itself for each of the first fold 153 and the second fold 154. In configurations, the flat, flexible cable 146 is fixed to the bridge. The flat, flexible cable 146 may be fixed to the bridge by, for example, glue or another adhesive. In configurations, the flat, flexible cable 146 is fixed to the bridge at the midline of the bridge. Fixing the flat, flexible cable 146 to the bridge may help to prevent the flat, flexible cable 146 from sliding within the bridge 119 during normal use of the game controller 100, where the game controller 100 may be repeatedly moved between the retracted configuration and the extended configuration. In configurations where the flat, flexible cable 146 is fixed to the bridge, the bridge may or may not include the tray 158 (as describe below), the flat, flexible cable 146 may or may not include the double fold 149, and the tray 158 may or may not include the double jog 160 (described below).

As illustrated most clearly in FIG. 4, the bridge 119 may include a tray 158 that is configured to contain the flat, flexible cable 146 within the tray 158. As illustrated, the tray 158 may include a narrow conduit 159 that is slightly wider and taller than the flat, flexible cable 146 such that the flat, flexible cable 146 fits snugly within the tray 158. The tray 158 is configured to prevent the flat, flexible cable 146 from bunching during normal use of the game controller 100, where the game controller 100 may be repeatedly moved between the retracted configuration and the extended configuration.

In configurations, the tray 158 may include a double jog 160, or turn. The double jog 160 in the tray 158 is configured to snugly contain the double fold 149 of the flat, flexible cable 146. Accordingly, the double fold 149 of the flat, flexible cable 146 coincides with the double jog 160 in the tray 158. The combination of the double fold 149 and the double jog 160 help to prevent the flat, flexible cable 146 from sliding within the tray 158 (and, therefore, within the bridge 119) during normal use of the game controller 100, where the game controller 100 may be repeatedly moved between the retracted configuration and the extended configuration.

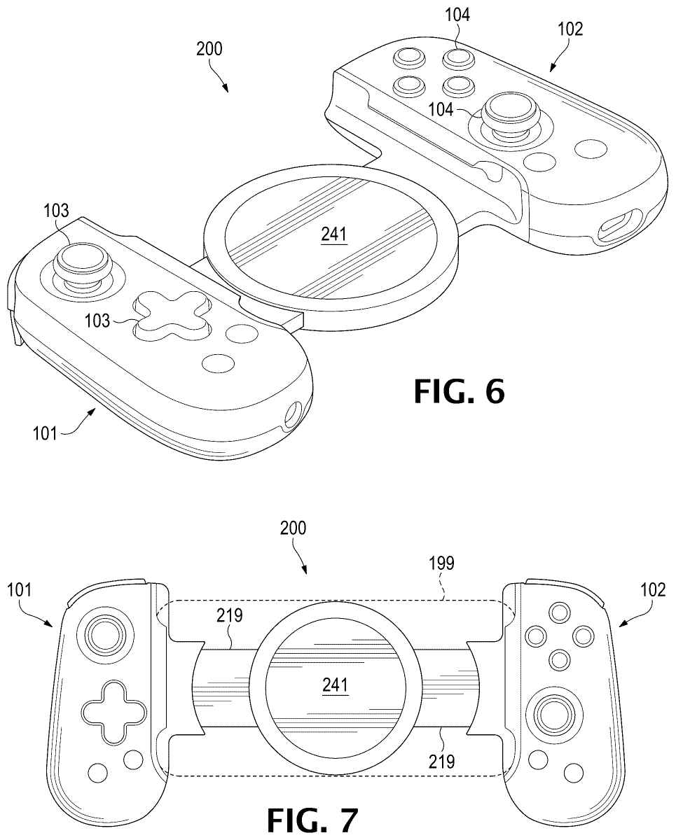

FIG. 6 is a perspective view of a game controller, according to embodiments. FIG. 7 is a top view of the game controller of FIG. 6, shown with an example mobile device. In addition to what is described here, the game controller 200 of FIGS. 6 and 7 may have the features and options as described above for the game controller 100 of FIG. 1. Accordingly, the same reference numbers are used.

As illustrated in FIGS. 6 and 7, in configurations a game controller 200 may include a magnetic connector 241 within the bridge 219. In configurations, the bridge 219 of FIGS. 6 and 7 may be as described above for the bridge 119 of FIG. 1, except as noted here. The magnetic connector 241 is configured to magnetically retain a mobile device 199 to the game controller 200. As examples, the magnetic connector 241 may retain the mobile device 199 to the game controller 200 by magnetic wireless connection, including by magnetic induction for near-field communication or for wireless charging, or both near-field communication and wireless charging. The wireless charging is to recharge the battery of the mobile device 199. In configurations, the magnetic connector 241 allows the mobile device 199 to be retained to the game controller 200 without a wired connection. As noted, in configurations, the wireless connection, provided by the magnetic connector 241, may allow the transfer of data between the game controller 200 and the mobile device 199 through near-field magnetic induction (NFMI). In configurations, the magnetic connector 241 may retain the mobile device 199 to the game controller 200 in addition to a wired connection, such as through the connector 125 (see FIGS. 1 and 2). In configurations that include a wired connection, versions may include spring mechanisms, such as the first spring mechanism 107 and the second spring mechanism 107 discussed above, to bias the first handle 101 or the second handle 102, or both, toward the retracted configuration, thereby helping to retain the mobile device. Other versions may lack one or both of the first spring mechanism 107 or the second spring mechanism 107.

Accordingly, in configurations the magnetic connector 241 may provide a wireless data connection, wireless charging, physical attachment to the game controller 200 through magnetic attraction, all three of those features, or any two of those features.

As illustrated in FIG. 7, a user may place the mobile device 199 onto the magnetic connector 241. While the mobile device 199 is shown in landscape position in FIG. 7, in configurations the mobile device 199 instead may be placed onto the magnetic connector 241 in portrait position. In configurations, the first handle 101 and the second handle 102 of the game controller 200 may be translated in the retraction direction toward the magnetic connector 241. In configurations, when the mobile device 199 is magnetically retained to the game controller 200, the first handle 101 and the second handle 102 contact the mobile device 199 as the first handle 101 and the second handle 102 translate in the retraction direction. To remove the mobile device 199, the first handle 101 and the second handle 102 of the game controller 200 may be translated in the extension direction away from the magnetic connector 241. In other configurations, the mobile device 199 may be removed from the magnetic connector 241 without the need to move the first handle 101 or the second handle 102 of the game controller 200, such as by lifting the mobile device 199 off of the magnetic connector 241.

In configurations, the magnetic connector 241 is not within the bridge 219 but is instead affixed to or within another part of the game controller 200, such as the first handle 101 or the second handle 102.

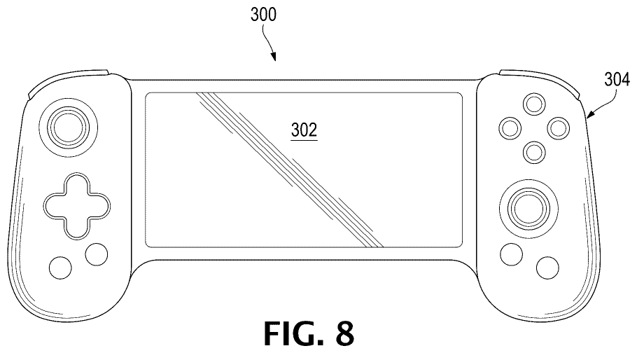

In another example configuration, such as illustrated in FIG. 8, an integrated game controller 300 comprises a display screen 302 integrated into a handheld controller 304 and does not require interfacing with a mobile device. Specifically, in this configuration the device 300 utilizes its own operating system and other software to perform the methods described elsewhere as being performed by the mobile device 199.

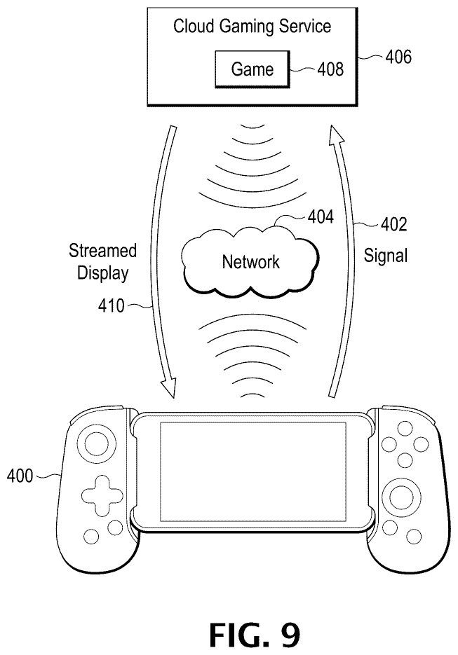

FIG. 9 illustrates an example environment for a game controller 400, which could be, as examples, the game controller 100 of FIG. 1, or the game controller 200 of FIGS. 6 and 7, or the game controller 300 of FIG. 8. In the configuration illustrated in FIG. 9, a game controller 400 sends a signal 402 over a network 404. The network 404 communicates the signal 402 to a cloud gaming server 406, wherein a game 408 is stored and run. The server 406, then streams a display 410 of the game back to the user at the game controller 400. In other configurations, the game play may be local, meaning that the game is stored and run locally, typically by the mobile device 199.

Example Mobile Game Controller

In this section, a mobile game controller is described that is designed for a computing device and interoperates with a platform operating service. In certain embodiments, the game controller specializes in high-performance input controls combined with custom protocols to empower the platform operating system. The embedded system within the mobile game controller comprises several subsystems that work together to enable rich features of the platform. Unique features enabled by this sophisticated embedded system can include one or more of: low-latency game controller inputs, custom platform-specific buttons (software service buttons), a software service indicator (e.g., a multi-color status light), pass-through charging, pass-through audio via external headset, platform operating service API and analytics, and cross-platform compatibility

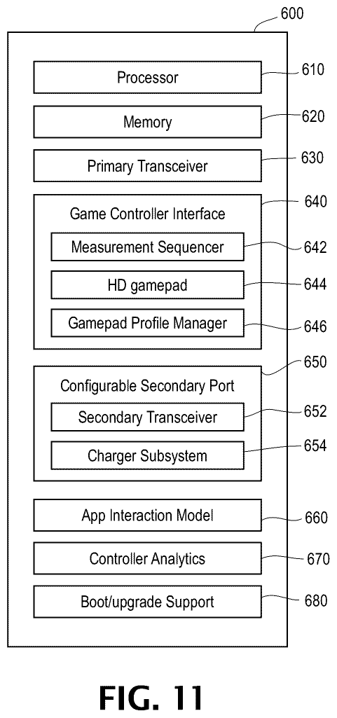

FIG. 11 is an illustration of subsystems 600 of an embodiment. As shown in FIG. 11, these subsystems 600 include a processor 610, a memory 620, a primary transceiver 630, a game controller interface 640 (which comprises a measurement sequencer 642, an HID gamepad 644, and a gamepad profile manager 646), a configurable secondary port 650 (which comprises a secondary transceiver 652 and a charger subsystem 654), an application interaction model 660, a controller analytics element 670, and boot/upgrade support element 680.

As with many embedded solutions, the system is powered by a processor (CPU) 610 with its associated random access memory 620. In addition, the system is connected to persistent external memory, which is used to store the program, configuration data, and any system information that need to be remembered across power cycles.

To establish connectivity to a mobile device, the system requires a transceiver capable of transmitting digital data over a serial bus. The bus can implement input events, audio, and bulk data traffic simultaneously if there is sufficient bandwidth on the bus. The mobile device can optimize bus traffic depending on the use case, but potentially at the cost of transmission latency.

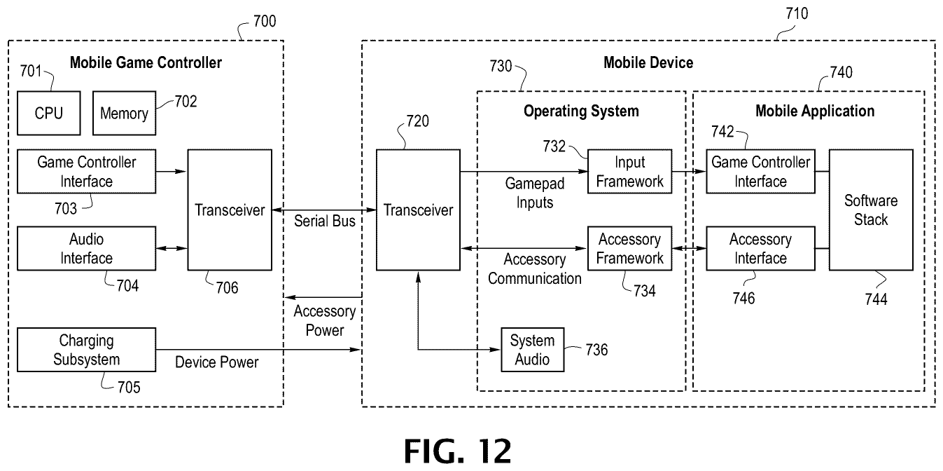

FIG. 12 is an illustration of a mobile game controller 700 and mobile device 800 of an embodiment. As shown in FIG. 12, this architecture comprises a mobile game controller 700 and a mobile device 710. The mobile game controller 700 comprises a CPU 701, a memory 702, a game controller interface 703, an audio interface 704, a charging subsystem 705, and a transceiver 706. The mobile device 710 comprises a transceiver 720, an operating system 730, and a mobile application 740. The operating system 730 comprises an input framework 732, an accessory framework 734, and system audio 736. The mobile application 740 comprises a game controller interface 742, a software stack 744, and an accessory interface 746.

In certain embodiments, the wired transceiver and serial bus can be replaced with a wireless RF transceiver and over-the-air protocol. For example, a Bluetooth protocol using the HID and serial port profiles can be interchangeable with the wired equivalents. Downstream functionality in the mobile operating system can be largely unaffected by the difference.

Game Controller Interface

The game controller interface can implement a measurement system which is designed to periodically measure the various surface inputs on the controller. The responsibility of the measurement system is to schedule and measure all of the input signals, both analog and digital voltages. The period of the measurement system directly impacts latency, and should ideally be as low as possible. A measurement interval close to 1 millisecond enables the controller to have a maximum input rate of approximately 1000 Hz. Practical rates are usually limited by the computing device, however.

Once all of the inputs have been measured, each input is translated into an input report. The format of input report is determined by a Human Interface Device (HID) descriptor. HID is a well established standard defined by USB-LF and is utilized broadly among devices which support game controllers. The HID descriptor defines collections of inputs and outputs for the device and how the respective reports are formatted. Both inputs and outputs in the HID descriptor are assigned usage values, which are generally standardized via the USB HID usage table. The assembled input reports can then be sent to the transceiver, rate throttled as necessary based on the mobile device on the other end.

If the mobile game controller is designed to work with multiple device vendors or platforms, it may be necessary to tailor the HID descriptor for each target platform. To address this in the embedded system, multiple HID descriptors can be organized into a profile system, where a profile contains: HID descriptor, HID usage map (surface input to HID input), Input Rate, Vendor ID/Product ID, and Other product strings and identifiers. In addition, when the mobile game controller has multiple transceivers, the profile will preferably need to specify one or more transceivers to interoperate with.

Configurable Secondary Port

To make the mobile game controller with additional platforms other than the primary computing device, a secondary port may exist on the product to enable USB connectivity to additional platforms. Example platform devices include PC, Mac, iPad, tablets, TVs, and game consoles. Since USB has become the charging standard for mobile devices, the system can combine the function of charging and game controller within the same port.

The platform operating service feature of configuring the secondary port for another platform is referred to as Play On Any Screen, and is explained in further detail in this document.

To implement a USB game controller on a secondary port, the flexible gamepad profile system can be reused used for the primary port, and simply target the secondary transceiver instead. In addition, due to the HID usage map that exists on every gamepad profile, there is no restriction in simultaneously mapping inputs to the primary and secondary transceivers. Once the surface inputs are read, it is just a matter of translating the input values into the format defined by the specified HID descriptor.

Software Service Indicator

The mobile game controller can support one or more software service indicators (e.g., a programmable status light with rich waveform support). In the current device, the status light has full RGB color support as well as brightness control. To achieve dynamic brightness, the processor utilizes programmable pulse width modulators (PWM) which allow for fine grain control over each color component's intensity.

A waveform management layer exists on top of the status light control, which enables more complicated patterns such as smooth in/out fading, and programmable duty cycle blinks. Waveforms also have a priority level which allows for multiple waveform states to run concurrently, but only the highest priority waveform is rendered. Waveforms that have the same priority level can optionally be configured to stack, in which case all waveforms at that level will execute in a round robin fashion, essentially taking turns based on the defined waveform period.

In addition to waveform brightness modulation for fading, the software service indicator can globally modulate its brightness via API control from the platform operating service. In some embodiments, the brightness level is synchronized with the brightness level of the mobile device screen.

Accessory Analytics

Within the embedded software, analytics are automatically aggregated for mobile game controller presses and hold durations. The analytics values are collected for every input over a period of time and sent up to the app in a single report. When the platform operating service application receives each analytics report, it has the opportunity to apply further processing and aggregation based on the use case. For example, the platform operating service application uses the analytics to identify when there is user activity to drive features that need an idle state.

In addition, the accessory analytics can be recorded in a real-time mode to supply game controller metadata to gameplay recordings. This can be useful not only as a scrubbing tool during editing, but also as a visualization tool of game controller input when viewing the video.

Communication Layer

In certain embodiments, the mobile game controller can establish a custom bidirectional communication link with the computing device. This serial interface allows data to be sent in two main use cases: (1) command-response, used for features such as firmware upgrade where the app initiates a command and waits for the accessory response; and (2) push messages, used for buttons and other asynchronous events where the accessory sends the message to the app.

Platform Operating Service API

To extend the functionality of the mobile game controller and mobile device, a protocol can be created to communicate with the platform operating service. The protocol utilizes the bi-directional communication protocol to exchange messages which enables various system features.

Custom Platform Buttons

Additional buttons not standard to extended game controllers can be sent up to the platform operating service as push messages. The button press and release events can be sent directly, along with the button hold time information. A custom platform button is an embodiment of a software service button defined previously.

If the platform communication link is not established, the mobile game controller may send internal transmissions to the mobile device itself to help locate the necessary software.

Status Light Control

The status light is an embodiment of the software service indicator. Control of the mobile game controller's status light is provided in the API to allow for rich color and waveform customization. Waveforms set through the API can coexist with any internal waveforms, and controlled via a priority level. Typically, waveforms set by the platform operating service will take precedence over the built-in waveforms.

Application Launch

The platform operating service can request to launch a specific application on the mobile device. Applies to mobile devices that support a rich accessory protocol.

Return to Menu

The platform operating service can request the mobile device exit to its normal operating mode/menu. This is achieved by sending a specific HID usage to instruct the mobile device to go back to its main menu.

Secondary Gamepad Profile

The platform operating service can set the gamepad profile for the secondary port on the mobile game controller. Setting the profile will write the configuration into persistent memory such that it is loaded by default when the game controller is operating via the secondary port.

Analytics Configuration

The platform operating service can configure the interval at which analytics are reported as well as a timeout before analytics stop sending when the controller is idle. Idle is determined when there is no change on any of the controller inputs, which would be redundant to send when all inputs are 0.

Analytics Reporting

Analytics are exchanged in two ways with the platform operating service. First, the mobile game controller can periodically send analytics report packets based on the configured interval. Second, the platform operating service can read out analytics manually through a polling approach. In either case where the analytics are accessed any accumulators or statistics are reset.

Firmware Upgrade

The mobile game controller can have the capability to upgrade the software on its embedded system through an upgrade mechanism. This upgrade process allows for the system to expand the functionality of the game controller as the capabilities of the platform operating service evolve. In the mechanism described here, the platform operating service makes the judgment whether a firmware upgrade is appropriate, and will initiate and control the upgrade procedure. For instance, to support robust and error free upgrading of a device powered game controller, the serial flash within the embedded system is partitioned into multiple regions. This helps to ensure that the area of flash being written to during the upgrade is not the same area in which the embedded system is operating from.

Additionally, the flash can further be subdivided as a file system so that a partition contains more than one binary file. For example, there may be a file for the program itself, a file for configuration parameters, and a file for embedded resource data. As part of the upgrade procedure, each file within the target partition is erased and written one by one, performing verification steps after each file is written. If the upgrade procedure is interrupted for any reason, such as if the game controller is unplugged, the upgrade can resume from the last completed step. Once all files within the target partition have been successfully written, the final step is to configure the system to boot from the updated region of the flash. The system can either reboot immediately, or configure the flash pointer and wait for the next power cycle.

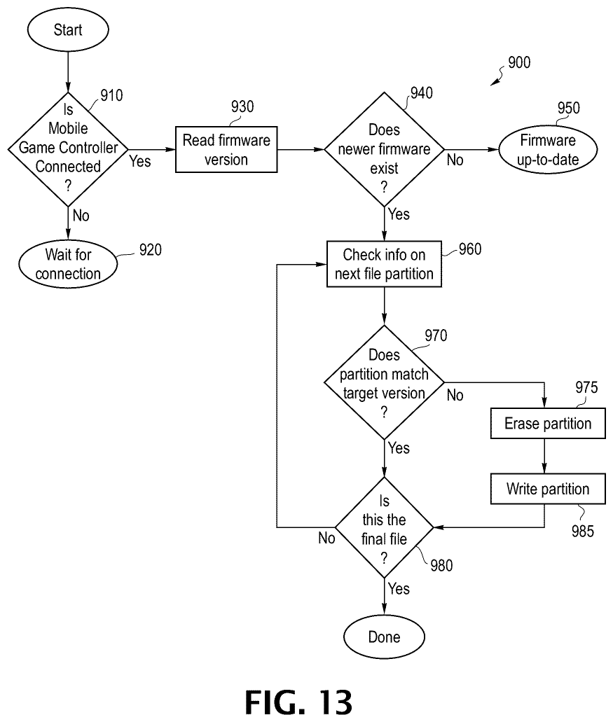

FIG. 13 is a flowchart 1300 of an example upgrade procedure of an embodiment. As shown in FIG. 13, a determination is made regarding whether the mobile game controller is connected (act 910). If the mobile game controller is not connected, the process waits for connection (act 920). However, if the mobile game controller is connected, the firmware version is read (act 930), and a determination is made regarding whether a newer firmware exists (act 940). If a newer firmware does not exist, the firmware is up-to-date (act 950). However, if a newer firmware does exist, info on the next file partition is checked (act 960) to see if the partition matches the target version (act 970). If it matches and this is the final file (act 980), the procedure ends. However, if it does not match, the partition is erased (act 975) and the partition is written (act 985).

Background Upgrade

In certain embodiments, when the mobile game controller is used in conjunction with a platform operating service, it is possible to conduct the upgrade of the embedded system when the integrated dashboard of the platform operating system is not visible. In this case, the platform operating service is continuing to run in a background operating mode to maintain the connection to the mobile game controller. The procedure need not be different when it is performed in the background as long as the platform operating service can maintain a constant communication link to the mobile game controller.

When the upgrade procedure has completed, the platform operating service may have multiple options to apply the new embedded system firmware: reboot immediately (or reboot as soon as possible), quietly stage new firmware and wait for next boot, and provide a notification indicating new firmware is ready

Play on any Screen—Overview

In the past, wired mobile game controllers could only be fully compatible with one computing device type, like an Apple iPhone or Android. As a result, users would have to own multiple game controllers to have an optimal experience across multiple devices (e.g., mobile, PC, Google Chrome or other web browsers, game consoles, Mac, smart TVs, living room entertainment systems, etc.). For example, in order to play on a traditional living room game console and a mobile computing device, a user would need to own at minimum both a traditional living room game console controller and a mobile game controller. This is due to a range of factors including, but not limited to, issues such as physical port incompatibility, interface protocol incompatibility, or software incompatibility. Although wireless game controllers, such as those based on Bluetooth, allowed for some multi-use scenarios, users had to deal with the potentially higher latency of the wireless connection on their traditional game console game controller.

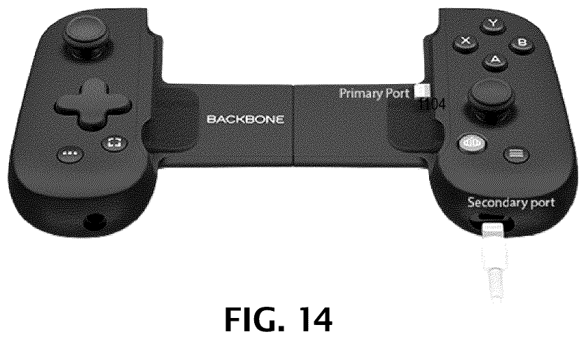

The Play On Any Screen feature allows the mobile game controller to intelligently detect when a port, such as the secondary port, is connected to another host device, and reconfigure the game controller interface. (FIG. 14 is an illustration of a game controller of an embodiment with primary and secondary ports.) By utilizing a secondary port, such as the charging port, the controller interface can be easily customized without affecting the primary game controller function. In certain embodiments, The Play On Any Screen feature is intuitive, and therefore it can eliminate, or reduce, the need for additional explanation in user manuals or education on how to reboot the device into different modes. Persistent memory inside of the controller helps to ensure that the Play On Any Screen function works when disconnected from the mobile device.

In certain embodiments, Play On Any Screen is one of the features of the mobile game controller system enabled by the configurable port. The configurable port allows a mobile game controller to be used with additional computing devices beyond the main devices they were designed to physically couple with, including, but not limited to a PC, Mac, iPad, Google Chrome. The wired connection of Play On Any Screen can offer superior end-to-end latency, lower than traditional Bluetooth-connected devices, which can provide a better user experience when a user is streaming games from the cloud. Through the combined system, which comprises embedded software, platform operating service and device operating system, users can now use their mobile gaming controller with other computing devices like iPad, Mac, and PC to play on external services such as Amazon Luna.

In certain embodiments, the user configures which additional external platform they would like to use via the platform operating service. The user uses an appropriate cable to wire the charging port to a capable host device. The smart mobile game controller system is able to intelligently detect when the charging port is connected to another USB host and is able to reconfigure as a USB game controller in a manner as to be fully compatible with the connected computing device. Persistent storage inside of the mobile game controller can help to ensure that the Play On Any Screen function works when detached from the computing device.

Example Configuration Flow

In certain embodiments, the platform operating service has an application installed on a computing device which communicates with the mobile game controller through the primary transceiver. In the case of a Lightning version of the mobile game controller, the primary communication for supporting the platform operating service application is through the Lightning protocol, and the secondary port communication uses a USB transceiver.

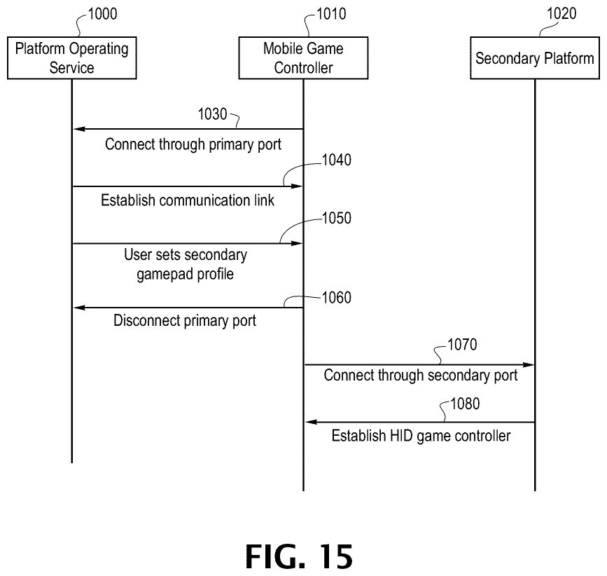

FIG. 15 is a diagram of a configuration flow of an embodiment between a platform operating service 1000, a mobile game controller 1010, and a secondary platform 1020. As shown in FIG. 15, the mobile game controller 1010 sends a message to the platform operating service 1000 to connect through the primary port (act 1030), and, in response, the platform operating service 1000 establishes a communication link (act 1040). After the user sets the secondary gamepad profile (act 1050), the mobile game controller 1010 disconnects the primary port (act 1060) and connects to the secondary platform 1020 through the secondary port (act 1070). The secondary platform 1020 then establishes the HID game controller (act 1080).

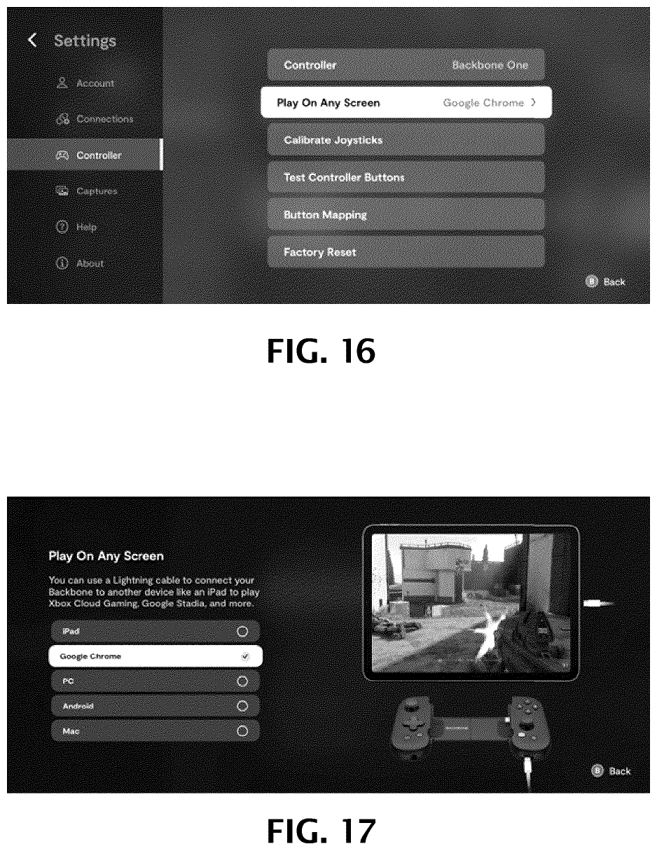

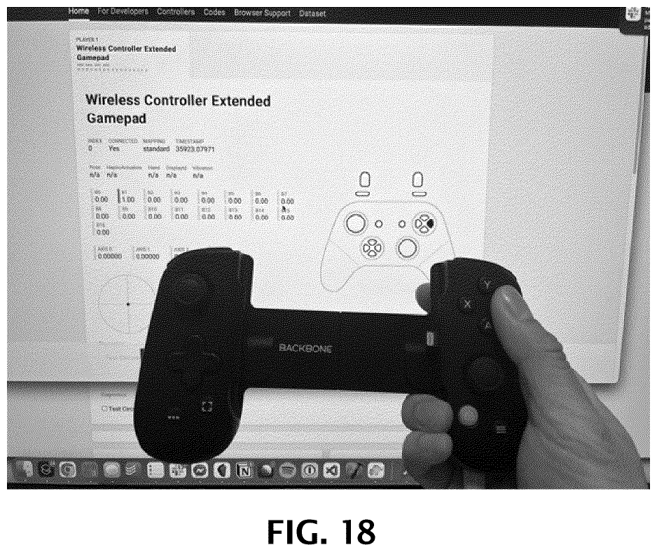

In certain embodiments, to use the feature, a user selects the device they want to play on in the platform operating service's settings (see FIGS. 16 and 17) and then they connect their mobile game controller to the device with a cable (e.g., a USB-C to USB-C cable or a Lightning to USB-C cable). The software service indicator can change state when this occurs to signal to the user that the device is being used with an alternate host device as opposed to the primary one. For instance, the software service indicator can be a status light that glows blue (or some other color or indication) in this mode to indicate that it's being used with another device. (See FIG. 18, which shows a user demonstrating the behavior of the Play on Any Screen feature, where a status light can change color when the functionality is active and in use.) With this feature, the end-to-end input latency can be lower than traditional Bluetooth controllers, making it optimal for cloud game streaming use cases.

### Example Implementation

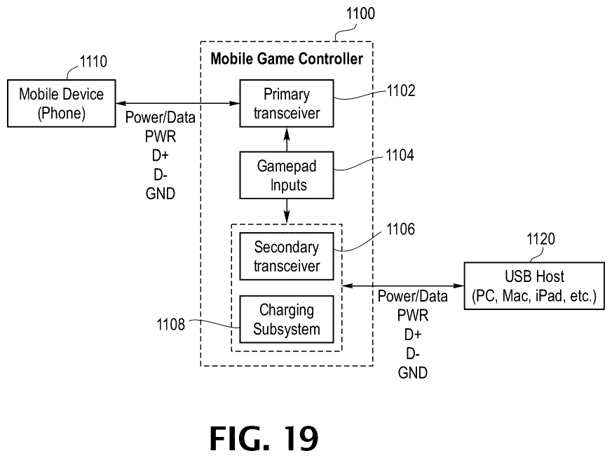

In certain embodiments, Play On Any Screen can be implemented based on a combination of key aspects of the system architecture: (i) configurable secondary port, optionally doubling as a charging port, (ii) HID game controller profile management in the embedded software, as well as flexible/reconfigurable USB endpoints in the microprocessor; and (iii) a platform operating service application on a computing device that communicates with the mobile game controller to assist in configuring the mode. FIG. 19 is a block diagram of a mobile game controller 1100, a mobile device 1110, and a USB host 1120 of an embodiment. As shown in FIG. 19, the mobile game controller 1100 comprises a primary transceiver 1102, gamepad inputs 1104, a secondary transceiver 1106, and a charging subsystem 1106.

Configurable Secondary Port

In certain embodiments, the configurable secondary port is used to establish power and data connectivity to a secondary host platform such as PC, Mac, iPad, etc. This secondary port can double as a charging port. When the primary mobile device is not connected, the pass-through charging function can be ignored, while the secondary transceiver on the port can be used to communicate with another device.

The mobile game controller can detect when a USB host is connected to its secondary port by monitoring the state of the USB differential data pins. There is little harm in turning on the transceiver regardless of the presence of a USB host, but some embodiments may probe the state of the data pins and suspend the device if a dedicated charging port is detected on the other side of the cable. A common approach to determine a dedicated charging port is to measure the voltage on the D+/D− lines of the USB. In the event that the lines are not in a J or K state (where + and − are opposite states), it can be inferred that there is not a valid USB bus on the other end.

When configuring the function of the secondary port, a specific game controller profile is specified, with each profile designed to specifically interoperate with the secondary host platform. Each host platform may have its own requirements or button mapping for HID game controllers which often requires platform specific customization. Some host platforms may have further requirements such as an authentication layer, which require further customization of the device descriptors. As an example, additional USB endpoints could be required to implement a platform specific communication and authentication protocol.

In certain embodiments, the configurable secondary port can make its decision on which game controller profile to use based on a physical input on the game controller. This can be a new physical switch or existing input on the controller surface. The embedded system can scan this input on connection to the secondary port, or scan continuously to reconfigure the secondary port on the fly.

In certain embodiments, the configurable secondary port can make its decision on which game controller profile to use based on an internal or external detection of the host device. As an example, the decision could be made by detecting the type of cable connected to the secondary port. The port could also provide an internal mechanism to identify the host, such as the use of a platform specific protocol utilizing vendor specific interfaces on the serial bus.

In certain embodiments, the configurable secondary port may implement a wired interface other than USB. In this case, equivalent game controller device paradigms can be used to implement the behavior of Play On Any Screen: (i) a communication medium to exchange information between device and host; (ii) a device descriptor which describes the device configuration to the host; (iii) a HID descriptor which describes how the surface inputs map to Human Interface Device inputs; and (iv) a mechanism in which HID inputs can be transmitted from device to host.

In certain embodiments, the primary and secondary transceivers of the mobile game controller may be the same physical hardware block. As an example, the mobile game controller may have a single USB transceiver which gets shared by both the primary and secondary ports. In order to manage the primary and secondary host device signals, a multiplexing solution is used to switch the single transceiver between multiple ports. The switch can then be managed by detecting whether the primary or secondary ports are physically connected. Usually the primary port takes precedence when plugged in, and the secondary port becomes active when the primary port is disconnected.

Game Controller Profiles

In certain embodiments, one of the key capabilities in the embedded software is the ability to reconfigure the game controller configuration to enable support of nearly any permutation of Human Interface Device (HID), and ultimately identify as many kinds of game controller. Each platform (PC, Mac, iPad, etc.) has its own limited set of devices they support out of the box which require tailored HID descriptors. In addition, software running on a platform may have additional button mapping requirements that can influence the requirements. For example, a web browser on a host platform may require a specific button mapping to work with a cloud gaming service.

Example Game Controller Profile Subsystem

At the top level, there is a single management module that controls which game controller profile should be used. Which profile to select is based on two factors: which port is currently active, primary or secondary (plug or receptacle), and which gamepad mode was specified by the user. The logic might use a lookup table.

For each game controller profile, there are several interfaces that can be customized based on the needs of the profile:

Top-level USB descriptor: This is the top-level configuration of the USB device, which encodes which USB interfaces and endpoints are used, as well as unique values like IDs or strings to uniquely identify with the USB host. In addition to preparing the data to send over USB, the descriptor data can be used to configure local USB hardware, such as endpoint type, direction, packet size, etc.

HID report descriptor: This is the data established over USB which encodes which game controller elements are present and how to pack/unpack the value for each. Each mode has dramatically different report descriptors, and even different encodings/mappings for buttons, joysticks, and triggers. HID usage map: A compact lookup table which maps surface inputs to HID usages present in the HID report descriptor.

HID input report builder: This interface takes the HID report descriptor data, HID usage map, and sampled game controller input values, and packages the data into a HID report which can be transmitted via USB. The rate of transmission is often dependent on the platform for which the profile is designed to work with.

USB event hooks: A USB stack provides various hooks that allow us to respond to USB events coming from the host. These events vary by implementation, but to give a few examples: USB HID class requests, USB set interface requests, USB endpoint and other kinds of interrupt events. The key here is that the USB stack handles a large percent of the low level communication details, but gives the option for these profiles to implement custom behaviors, effectively minimizing the amount of redundant code needed for each gamepad type.

In certain embodiments, the HID report descriptor is parsed directly inside the embedded system in the same way that a host device would. This unlocks functionality that requires dynamically assigning bit/byte positions when building HID input reports. By including the parsing within the embedded system, the descriptor and usage maps can be sent directly without requiring post processing by the platform operating system.

Embedded Software Updates

To increase flexibility of the system, certain embodiments may utilize the platform operating system to update the game controller profiles supported by the mobile game controller. In one embodiment, the platform operating system updates the embedded system through a firmware update. In this case, new embedded code can be added to extend existing profiles or add new profiles.

In certain embodiments, game controller profiles can be established by the platform operating service and written to the mobile game controller via the platform operating service API. In this case, controller support can be added to new platforms by transferring just the game controller profile data. In this embodiment where the mobile game controller can be represented by a standard HID descriptor, a common game controller profile can be customized by externally driven data. The profile can be transferred as a HID report descriptor and a HID usage map and stored to the embedded system's persistent storage.

Analytics

An important potential challenge with this feature is obtaining usage metrics and debugging issues in the field (e.g., suppose there is an issue in recognizing the mobile game controller as an input device on a particular version of iPadOS.) Since the Play On Any Screen feature can be used with a different computing device as opposed to just the primary computing device for the mobile game controller, usage stats and analytics are recorded and stored in the mobile game controller's embedded storage, then read out on the next connection to the platform operating service application installed on the computing device and communicated with the platform operating service's cloud service. This implementation enables off-platform data and analytics collection.

In certain embodiments, the secondary platform connected through the secondary port can supply analytics data to the mobile game controller. The analytics are communicated through the secondary transceiver and stored into the mobile controller's embedded storage to be read out on the next connection to the platform operating service.

Content Capture System—Overview

Options for recording gameplay on a mobile computing device were limited until a capture system was introduced that enabled recording, streaming, edit, and sharing as part of an end-to-end system for mobile device game capture.

Traditionally, device operating systems bury screen video recording in a setting shelf, and in some cases do not expose the feature by default. The capture system allows the user to start/stop capture recording without having to remove their hands from the mobile game controller. By integrating a software service button and embedded software function into the gameplay device itself, the feature can reach a large audience. In addition, because it is very easy to access and low friction, users are not taken out of the game to access the feature.

In certain embodiments, the feature can be organized into three main areas: (1) control signals and status indication, (2) background audio/video pipeline; and (3) content upload, delivery, and tagging powered by backend servers. Through testing with users, it was observed that start and stop recording functions, while certainly useful, also are not sufficient for all functions. On occasion, a player may only realize that an interesting gameplay moment occurred after the fact. In this scenario, being able to trigger a flashback recording, or retroactively grab video or audio buffers (e.g., the last 30 seconds of video or audio) is useful. Similarly, users may also want to live stream to another destination or share their screen with other users in the platform operating service.

Example Capture Modes

Example capture modes include screen recording, screen sharing, live streaming (to a live streaming service such as Backbone, Twitch, YouTube, Facebook, etc.), and flashback recording. A capture button is a software service button that enables screen capture on a mobile game controller. A capture button can be integrated with the platform operating services to support other forms of capture besides start and stop recording; namely enabling streaming, screen-sharing, and flashback recording. Note that the term “capture” is used to describe these different forms of capture.

One issue with capturing mobile gameplay is that content creators oftentimes do not know when the capture is actually occurring. For example, a YouTube or Twitch content creator may use the built-in operating system interface to capture the screen. In some examples, the mobile operating system may not provide a sufficient visual affordance for indicating that the screen is being captured. Further, doing so may occlude gameplay on the screen which is harmful to the user experience. Thus, content creators may play for an extended period of time, only to realize after the fact that none of their session was recorded because, for example, the screen was not being captured or the built-in screen capture crashed in the background.

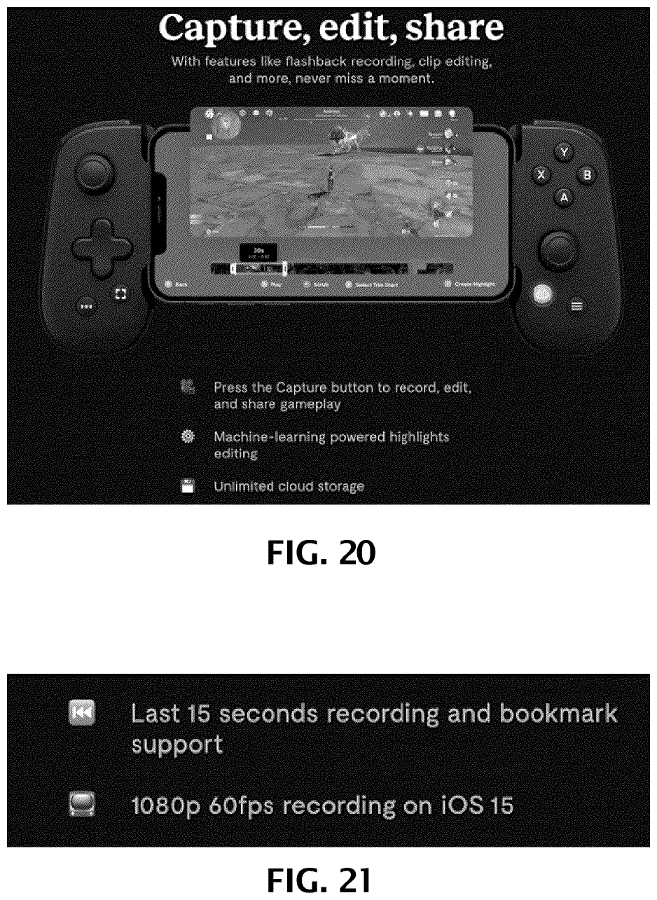

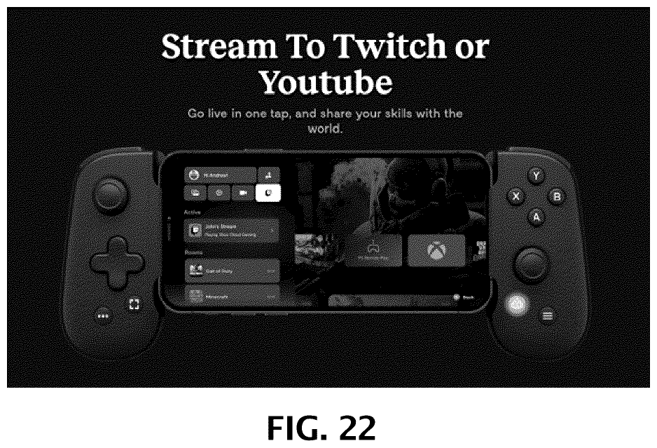

When a mobile game controller is combined with the screen of the computing device, the screen of the computing device would normally have to be relied solely on to understand the state of the capture system. In the smart mobile game controller system, there is a unique solution in that a software service indicator, such as a status light, can be used to indicate that the screen is being captured without occluding screen real estate. FIGS. 20-22 are screen shots that illustrate these features.

Control and Status

On the smart mobile game controller there can be a software service button (e.g., a Capture Button) to allow you to capture gameplay (e.g., start/stop recording or streaming). There can also be a software service indicator on the device to indicate broadcast/capture status. In addition, the device operating system can serve as a control and indication mechanism, using the display and interactive controls to enable the capture functionality. Regardless of the initiation source, the platform operating service application and embedded software can work in harmony to provide the user with a single, consistent, visual and tactile affordance that readily communicates state even if the application is in the background. These affordances include, but are not limited to, software service indicators.

The software service indicator can give users instant, or substantially instant, feedback on the current capture state and functionality. To indicate to the user that a capture is occurring, for example, a status light can be illuminated. This light can be further customized to communicate additional state details such as applying a color profile or pulsing pattern to provide functionality insight at a glance. One example of this is utilizing associated brand colors with active service integrations, such as pulsing the status light the associated shade of purple when the user is streaming to Twitch. Further, in the case of a status light, a platform service indicator, the illumination state, color, illumination patterns, and brightness can also be changed to provide visual cues to the user. These states can be singular, or enhanced to provide overlapping visual queues to the user at any time. For example, while recording and streaming, the status light can be illuminated and pulsing between the assigned capture color (Red by default) and the color of the associated streaming service (example: Purple for Twitch).

The software service indicator can of course be supplemented with one or more on-screen affordances as well. In some embodiments, the on-screen affordance can be inside the platform operating service application and/or in the mobile operating system. In certain embodiments, the platform operating service, because it can potentially be accessed through the software service button, can also indicate on the screen the current state of the capture system in lieu of or in conjunction with a software service indicator. In certain embodiments, the platform operating service can stop an outstanding capture session on the disconnection of the mobile game controller.

### Example Implementation

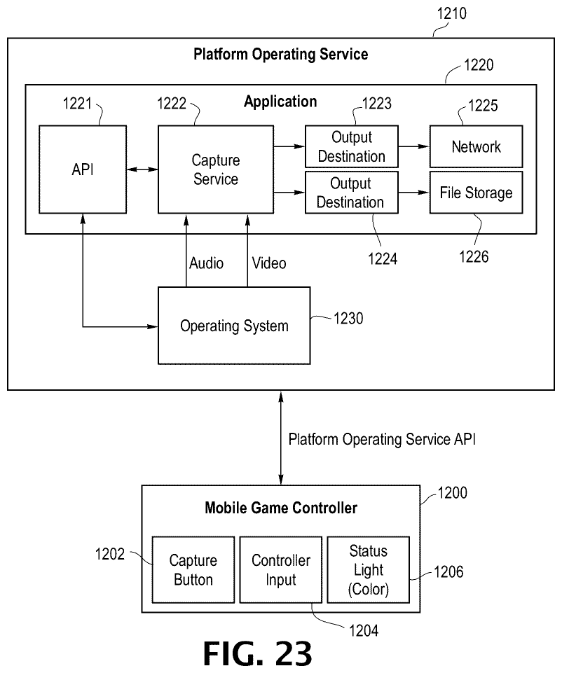

In certain embodiments (see FIG. 23), the capture system is implemented through coordination of the mobile game controller 1200 and the platform operating service 1210. As shown in FIG. 23, the mobile game controller 1200 of this embodiment comprises a capture button 1202, controller input 1204, and a status light 1206. The platform operating service 1210 comprises an application 1220 and an operating system 1230. The application 1220 comprises an API 1221 and a capture service 1222 that outputs output destinations 1223, 1224 to a network and file storage 1225, 1226, respectively.

The mobile game controller 1200 provides the surface buttons and status indicators for the capture system. The platform operating service 1210 provides the screen and audio capture capabilities and handles interfacing to various cloud services. Using a platform operating service API 1221, the two systems exchange status and control information to create a capture system that is accessible and useful to the user.

Mobile Game Controller

In certain embodiments, the mobile game controller contains a software service button (capture button) which can be used to interact with the capture system of the platform operating service. Through the platform operating service application, the capture button, a software service button, can invoke various recording functions based on the use case. For instance, in screen recording mode, a short press starts/stops recording, and a long press saves a marker in the recording. In flashback recording mode, a short press starts/stops circular buffer recording, and a long press saves the last N seconds from the circular buffer. In screenshare mode, a short press starts/stops screensharing/buffering, and a long press saves the last N seconds from the circular buffer (Flashback recording can run concurrently with screensharing). In live stream mode, a short press starts/stops livestreaming/buffering, and a long press saves the last N seconds from the circular buffer (Flashback recording can run concurrently with live streaming).

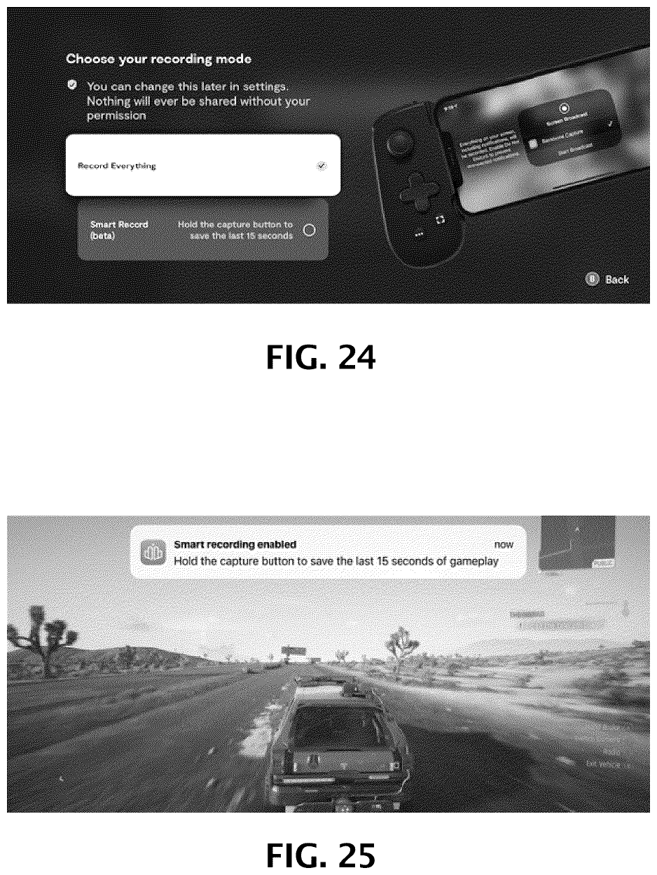

In some embodiments, the Capture Button, as a software service button, can have special behaviors when the platform operating service application is in the foreground. For example, the device operating system can have its own circular buffer of length N seconds, and therefore when the user is streaming cloud games in the platform operating service, they don't have to request user permission. In some embodiments, the Capture Button, as a software service button, can have user programmable behaviors where the function of the button is defined by a user setting in the platform operating service settings. For example, a user may select whether they want a traditional capture recording button or to use the flashback recording feature. FIGS. 24 and 25 are screen shots related to the recording features.

Example Status indication

Based on the currently-active output destinations, one or more LED patterns are selected and sent to the connected controller. When multiple LED patterns stack, the patterns alternate to allow for multiple states to be shown simultaneously.

Platform Operating Service

In some embodiments, the platform operating service implements the capture system through a service running on the mobile device which is able to capture audio and video data, compress/encode into the required format(s) and transfer to the specified output destination. The capture service operates in the background in order to record gameplay, and communicates with the platform operating system application through a bi-directional messaging interface. Example messages include: Add output destination (start recording), Remove output destination (stop recording), Report capture status, Software service button pressed, and Error has occurred with the output destination.

Broadcast and Capture Service

The capture service can be described as an audio/video pipeline. In the simple case, audio and video routes to a single destination, but in more complicated cases multiple output destinations can be active at the same time. On a mobile device, there is generally one interface to the mobile operating system audio/video stream, and therefore a common entry point for input samples can exist when supporting multiple destinations. Audio/video samples can then be multiplexed and routed to feature specific sample handlers.

Audio/Video Pipeline

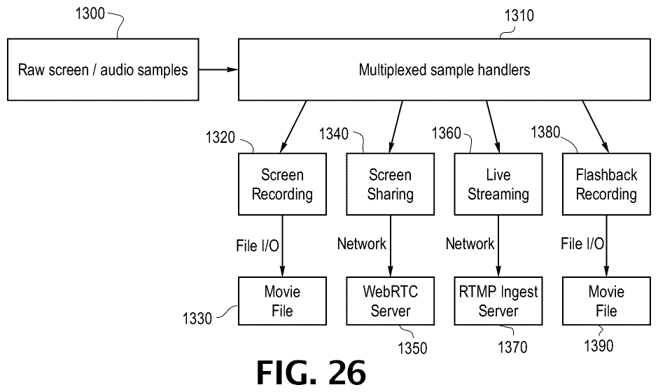

FIG. 26 is a block diagram of an audio/video pipeline of an embodiment. As shown in FIG. 26, raw screen/audio samples (raw video and audio sample data) 1300 are provided to multiplexed sample handlers 1310 with independent start/stop controls for each interface. Multiple possible output destinations allowing for simultaneous operation and delivery. For example, the multiplexed sample handlers 1310 can output a screen recording 1320 which is sent via file I/O as a movie file 1330, screen sharing 1340 which is sent via a network to a WebRTC server 1350, live streaming 1360 which is sent via a network to an RTMP ingest server 1370, and a flashback recording 1380 which is sent via file I/O as a movie file 1390. The service scales based on active outputs, with the ability to add/remove while running. The service can shut down when the last output is removed, and start when one or more outputs are added.

Audio and Video Sample Data

Video frames are delivered from the mobile operating system as pixel buffers, which have a buffer descriptor defining the pixel format, e.g. 32-bit RGBA. Each frame is given a timestamp which helps encoders establish the frame rate of the video. For efficiency, video frames often arrive in a buffer list which represent a list of video frames over some period of time. The downstream encoders therefore need to be capable of unpacking several buffers at a time, and will consider the embedded time stamps when controlling the frame rate.

Audio frames are delivered from the mobile operating system in a similar way as pixel buffer, except their buffer descriptor defines the format of PCM audio, such as the number of channels, bit depth, and sample rate. Audio buffers can also arrive in a buffer list and timestamps are important for the encoder to match up with the video frames.

Usually the capture system records the gameplay audio, but some mobile operating systems may supply voice audio from a system or external microphone. In this case, the voice samples arrive in a similar way as the audio frames, but may need to be mixed before reaching the encode. However, some sophisticated MPEG encoders may support multiple audio tracks which can reduce the complexity in the capture service.

Sample Handlers

In this description of the capture system, a sample handler is a sub-feature of the service which implements a single output destination. Output destinations may be local for gameplay recording or broadcast externally for streaming destinations.

Example Screen Recording

For this mode, audio and video samples are streamed into an MPEG encoder and progressively written to disk until the process is stopped by the user. Resolution, bitrate, and framerate can all be specified by the user.

Example Screen Sharing

For this mode, real-time media credentials are established when the handler is started which handles authentication as well as which room to share in. Once connected, audio/video frames are encoded and queued for upload to the real-time media server. Resolution, bitrate, and framerate are automatically handled by the feature to optimize for responsiveness.

Example Live Streaming

For this mode, a RTMP (Real-time messaging protocol) ingest server endpoint is established when the handler is started which determines which live streaming channel will receive the video content. Audio/video frames are adaptive encoded, based on the server bitrate limits as well as network performance.

Example Flashback Recording

Audio and video samples are encoded on the fly into segments, but instead of uploading to the web as with an HLS (HTTP Live Streaming) use case, the segments get written into a file based circular buffer continuously. A short history (for example 15-30 seconds) is maintained, where the oldest segments are replaced with new segments in a circular fashion. When a recording is requested, the various segments are assembled in chronological order to produce a movie file.

One important criteria of the flashback recording feature is that the recording mechanism continues to run even if a request to save video occurs. This means that the system is capable of exporting a movie while simultaneously managing new segments in the circular buffer.

Example Content Delivery and Upload

Through coordination of the device operating system and platform operating services, user captured audio/video content can be uploaded to the platform operating service, and ultimately delivered more broadly to other users.

Captured Gameplay

In certain embodiments, gameplay that is captured to file can be uploaded to the platform operating service and distributed through a content delivery network. Metadata from the associated gameplay is automatically stored on the platform operating service to power search and content discovery.

Live Streamed Gameplay

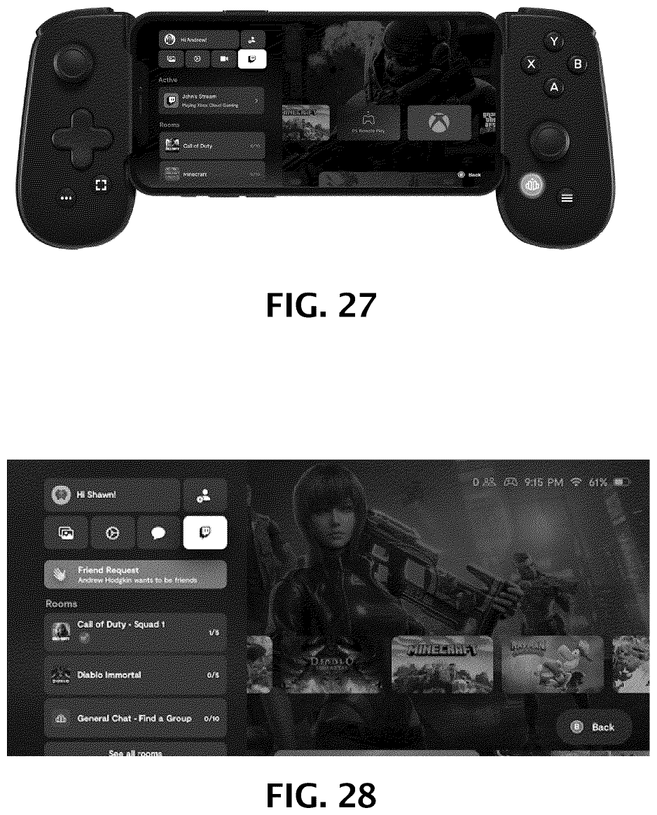

In certain embodiments, gameplay can also be streamed live to various first- or third-party services like Twitch and YouTube (see FIG. 27). The platform operating service tracks concurrent user live streams and screen sharing sessions to notify other users of watchable content.

Smart Record

Smart record is an example implementation of the flashback recording feature within a platform operating service, with deep integration with the mobile game controller.

Flashback Recording

In certain embodiments, the flashback recording implementation uses a recording mechanism similar to HTTP live streaming (HLS), where the audio/video encoder is configured in segmentation mode. In this mode the encoder will output multiple movie fragments rather than one single continuous movie. With HLS, each segment would be uploaded to a streaming endpoint on a periodic interval. Instead, the segmentation interval is set to 1 second, and each segment is stored into a circular buffer. To reduce runtime memory requirements, each segment is written to computing device storage, with a limit on the maximum number of segments that can live on the computing device local storage at any given time (usually N+M where N is the number of seconds of flashback memory, and M is the number spare/scratch buffers to help prevent overrun). Once the circular buffer is full, any new segments replace the oldest segment in a circular fashion.

The flow may comprise of the following steps:
Setup audio/video encoder in segment mode
Save initialization segment from the encoder for use as movie header in final output file
Setup circular buffer of N+M movie segments, 1 sec intervals; where N is the number of seconds of flashback history and M is number of extra seconds of buffering to avoid segment overwrite during video export. Write pointer points to the oldest segment, read pointer is always N entries forward from write pointer.
Observe screen/audio buffers uncompressed and feed into audio/video encoder.

For each movie segment out of the encoder, write the segment into the circular buffer until a stop event occurs.

When a “create flashback recording” event arrives, write initialization segment as movie header, and write N movie segments based on flashback history depth. One or more movie segments may arrive during this process, flashback history should have M movie segments of extra space to avoid overrun

In certain embodiments, the flashback recording mechanism may need to be started or ask for user permission before starting. In this example, the user would first press the capture button to initiate the capture service to enable recording, and then would use a different button gesture to save a flashback movie to their capture gallery. For example, a short press can start/stop flashback recording service, and a press-and-hold can save flashback movie and remaining recording.

While the flashback recording mechanism is running, some embodiments may use a software status indicator to indicate the system is actively supporting flashback recording mechanism. The status indicator can change its state based on if the flashback recording service starts, stops, or successfully creates a flashback movie. For example, no status light when flashback recording is stopped, a solid yellow light when flashback recording is running, and a triple blink pattern on the yellow light when successfully saving a movie

Automatic Recording

In certain embodiments, the process of triggering a flashback movie to be saved can be automatic. Instead of requiring the user to press a software service button, the system may instead create movies automatically using additional context from the mobile game controller. For example, a real-time controller analytics stream can be analyzed to determine peak activity on the controller inputs to decide to save a movie.

Movies that are saved from the same recording session can be grouped by the platform operating service so they can be quickly reviewed simultaneously, allowing for more efficient editing of gameplay. Grouping movies of the same recording session also has the benefit of being able to combine or stitch the content more easily.

Live Streaming

In certain embodiments, this document describes live streaming gameplay on a device operating system in conjunction with the mobile game controller. The system can be designed to enable for “one-touch” control of the live stream, allowing for the broadcast to be controlled from a software service button. In some embodiments, the control of the live stream can also be implemented through a user interface inside the platform operating service application. The interface can either be a controller interactable button or a touch surface. In the absence of a software service button, such as when a mobile game controller is disconnected or does not support a software service button for capture, an alternate interface can be presented in place of the controller button. See FIGS. 28 and 20 are screen shots that illustrate a live streaming feature of an embodiment.

The following subsystems help implement a seamless live streaming experience: account linking, audio/video capture and streaming, and accessory service capable of background operation.

Account Linking

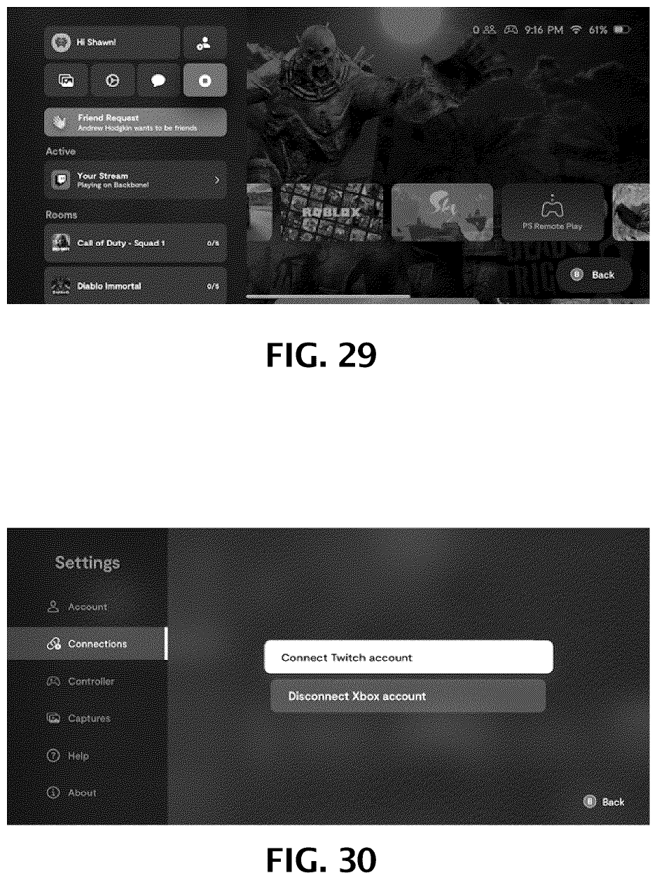

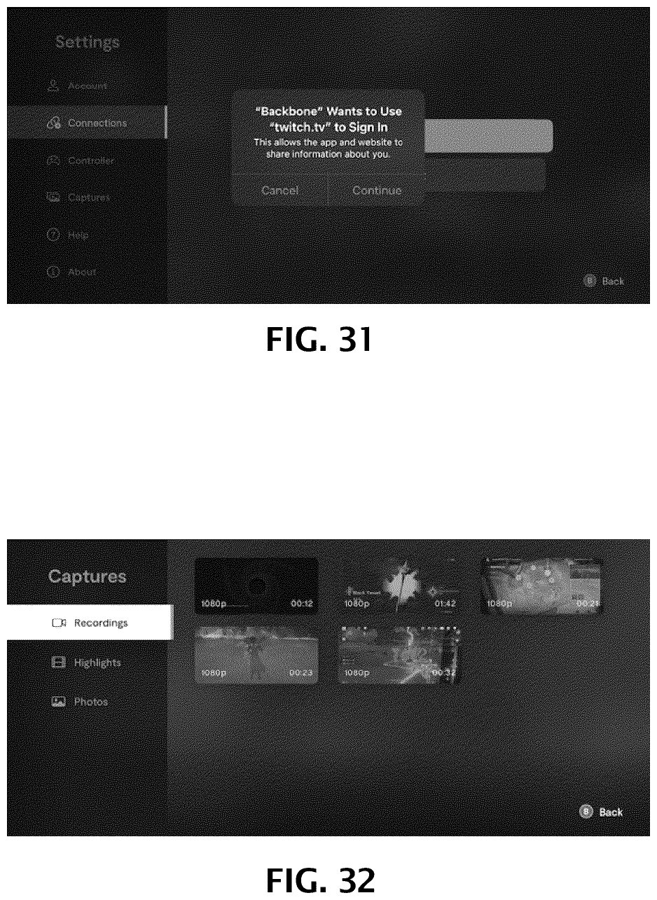

FIGS. 30-31 are screen shots that illustrate an account linking feature of an embodiment. To set up a live stream within a capture service, it may be necessary to do a one-time setup to link the user account with the platform operating service. The platform operating service application requires a proper stream key which in turn determines the destination URL for the live stream ingest server. Most popular live streaming services provide an API to link the account, but it is also possible for the user to manually enter their stream key or manually input the URL to the ingest server.

In certain embodiments, the platform operating service provides a user interface to connect and link a live stream account with the platform operating service application. Once the account is linked, the stream key and other live stream channel information (user name, channel name, etc.) may be accessed from the live streaming API and used in conjunction with the audio/video capture service to enable live streaming of gameplay.

In certain embodiments, the platform operating service provides a user interface to manually enter a stream key for a live streaming account which can be used in conjunction with the audio/video capture service to enable live streaming of gameplay.

Audio/Video Streaming

In some embodiments, the platform operating service has established the stream key and/or ingest server URL, a RTMP connection is formed with an RTMP server in preparation for streaming audio/video content to the live stream.

To get gameplay audio/video to the live streaming service, the screen and system sounds need to be captured and converted via MPEG encoder. The encoded frames then get passed on to a broadcaster module which handles packaging in the RTMP frame format and sending through a network transport to the established RTMP connection.

In additional embodiments, other video transport protocols (e.g. Secure Reliable Transport, HTTP live streaming) can be used to stream audio/video content to a live stream with adjustments for any encoding specifications.

Status Indication

In some embodiments, a software status indication can be used with a mobile game controller to show the live stream status, such as a status light. The broadcast status in this case is communicated from the platform operating service to the mobile game controller.

In certain embodiments, the status indication may be set by the platform operating service for display within the operating system of the computing device. The operating system may allow for status indication in its status bar, system notifications, and other places where system status can be found.

Capture Edit/Upload—Capture Gallery

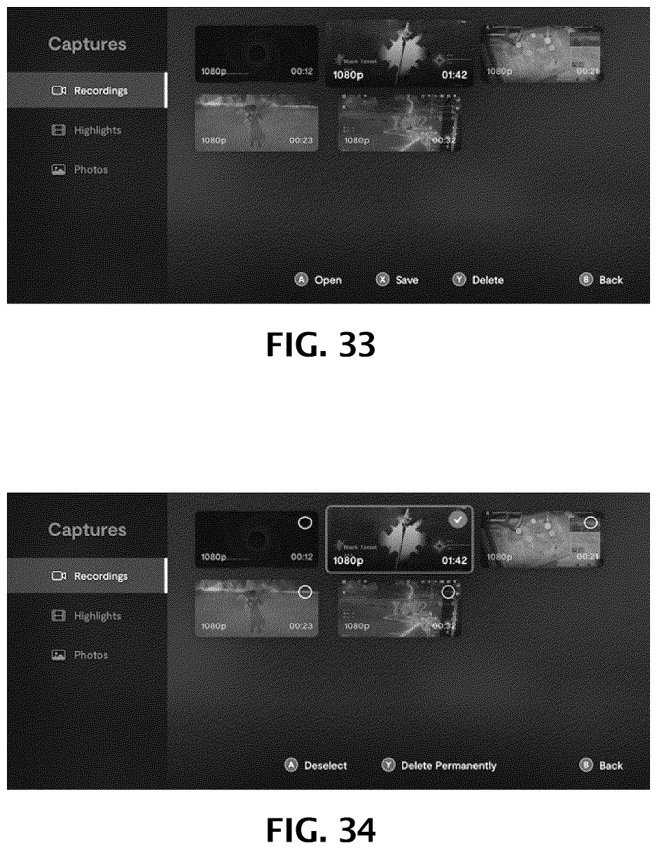

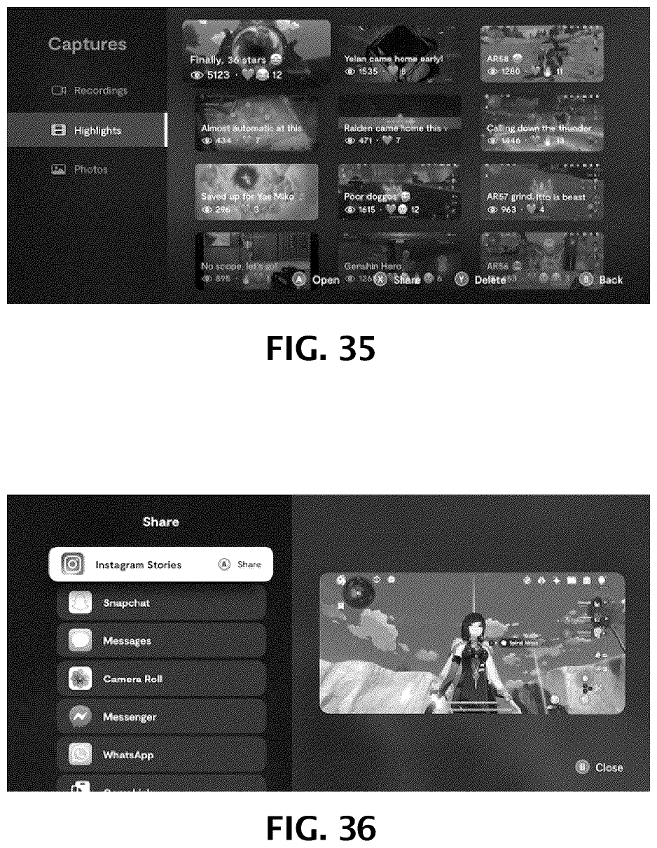

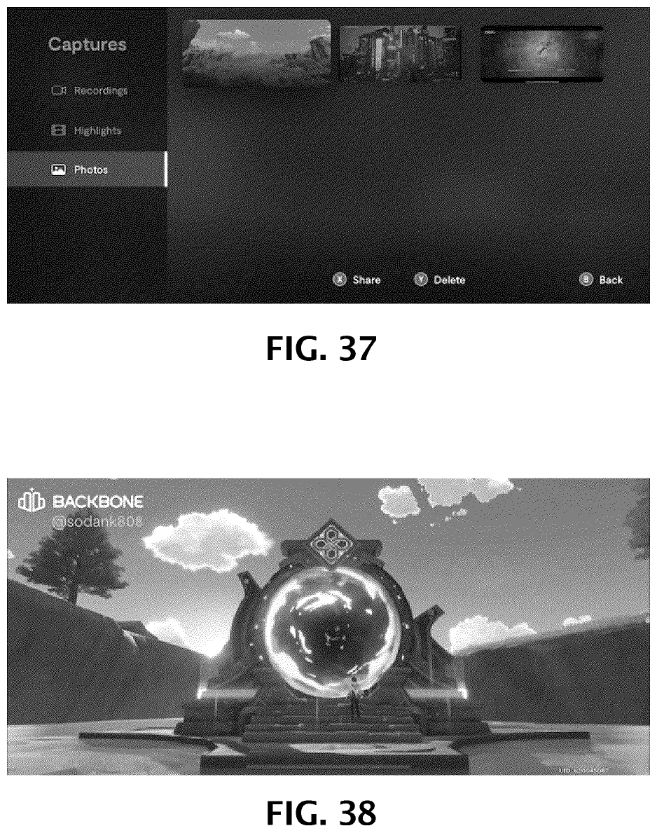

In certain embodiments, once a video clip has been recorded, it is copied into the platform operating service application's local storage for easy access to view/edit. All outstanding videos and screenshots are organized into a gallery within the platform operating service application with the ability to view, edit, share, and delete. In addition, the capture gallery shows any videos that have been uploaded to the platform operating service, which is described herein. FIGS. 32-37 are screen shots that illustrate a capture gallery feature of an embodiment.

Watermarking

In certain embodiments, a recorded video may be watermarked before uploading or saving externally. A watermark can be a static or moving image or text that is blended into the video to track its original creator and/or program that created it. FIG. 38 is a screen shot that illustrates a watermarking feature of an embodiment.

Example Video Editor

When viewing original video recordings, the platform operating service application allows the user to edit and trim their video in preparation for uploading to the platform operating service. The in-app video editor is designed to be fully controller navigable, using the joysticks of the smart controller to quickly scrub through video in an ergonomic fashion, and utilizing the mobile game controller button shortcuts to toggle between the trim handles. When the user moves the joystick left and right, the scrub position of the video is altered and the preview of the current video frame is updated in real-time. There are three scrubbing modes: (1) scrub start position of trim window, (2) scrub current position of preview playback, and (3) scrub end position of trim window.

As part of the editing workflow, the user will need to establish where the clip starts and ends. To do this efficiently, the user will playback the video and pause at the point where they want the video to start. Once the position is identified, they can use a mobile game controller button to create the start and end markers. The user can then use the mobile game controller buttons to quickly toggle between the three scrubbing modes, usually previewing the video after making slight adjustments to the clip endpoints.

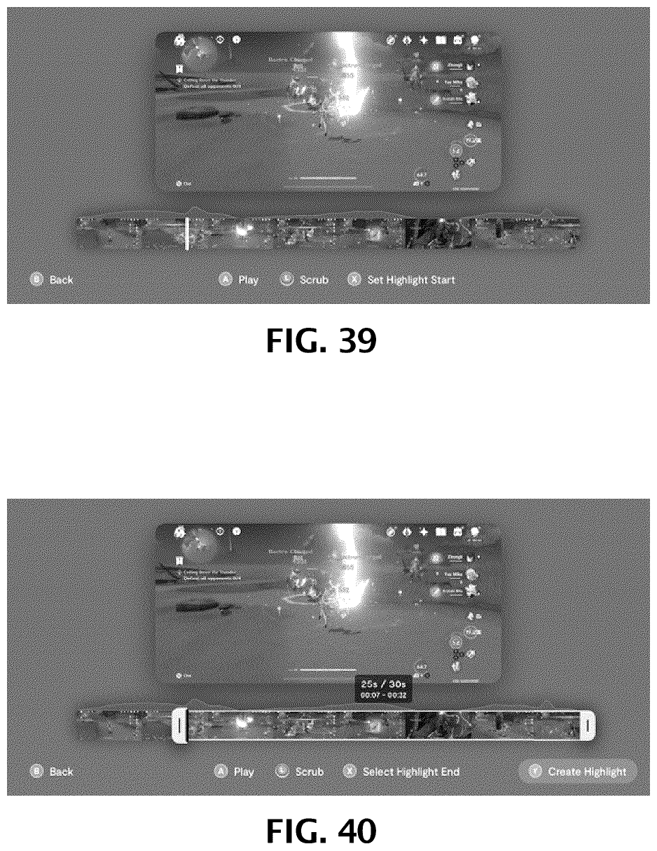

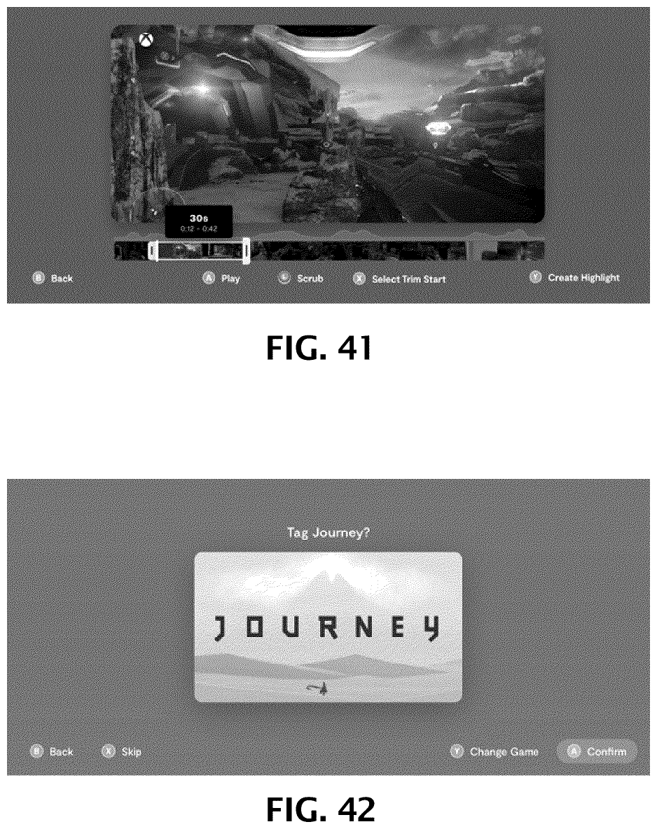

To aid in the editing of long videos, an activity waveform is shown in the video timeline in the screen shots of FIGS. 39-41. This waveform is derived from the controller input activity while the gameplay was recorded. The signal itself is essentially a weighted sum of all of the controller inputs at each point in time. The resulting waveform tends to be quite noisy, so the signal is finally processed through a moving average filter to smooth out the visualization. The end result is that areas of gameplay with significant game controller activity show up as peaks in the waveform, and places where the user is waiting on loading screens, awaiting player respawn, etc. are visualized as low activity. This can significantly improve the efficiency of finding points of interest within a video recording.

Game Tagging

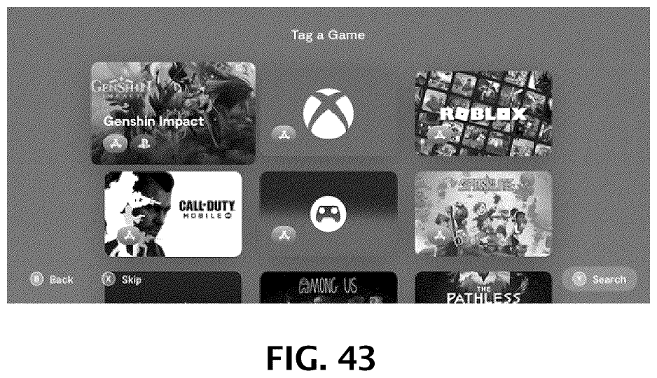

In certain embodiments, using a combination of the software service button and a universal search feature, users can easily tag the game that was recorded in their video. The application can track when a user launches a game from an application user interface, such as the personalized dashboard and from the universal search functionality. In some embodiments, the application can also detect when a user launches a game from outside the application by interacting with the device operating system. This launch detection functionality can be utilized to detect what games were played during the recording period and suggest these games to the user. The user can then confirm the game tagging suggestion (see FIG. 42). In the case that the source of the recording is unknown or incorrect, the user can search for and select the game to be tagged (see FIG. 43). The software application can prioritize games the user has previously played or have been detected, then provide a search prompt to tag any game within the platform operating service.

Example Video Upload

Once a video has been trimmed within the minimum acceptable length, the user can save and upload the clip to the platform operating service. In certain embodiments, this is a two-step process. First, the clip is uploaded to the content delivery network that hosts the video. For the best user experience, a CDN can be used which provides flexibility in streaming the video using HLS technology at various bitrates and resolutions. Once the file is uploaded to the CDN, the source url is passed on to the platform operating service along with other metadata for the video such as author, tagged game, and other video attributes important for the viewing experience.

When a video is added to the platform operating service, it is associated with the logged in user so that it will appear in the local user's profile as well as in certain areas of the dashboard that include user generated content. For example, gameplay video uploads that are correctly tagged can appear on game detail pages for other users. Additionally, videos can show up in recent and trending rows on the Integrated Dashboard.

Platform Operating Service with Integrated Dashboard—Overview

One of the important issue users of a mobile game controller face is that they are not able to access all of the content across multiple distinct services in a straightforward way. Mobile app stores do not necessarily have an incentive to enumerate or index individual game titles that can be played through use cases such as console/PC remote play or cloud game streaming. This is largely because streamed content is typically consolidated into a single app (e.g., Netflix or Amazon Luna) and because some of this content can be streamed on a host device wholly separate from the computing device connected to the mobile game controller as is the case with console/PC remote play.

In certain embodiments, a smart mobile game controller has one or more integrated dashboards. This software transforms the computing device into a significantly more capable end-to-end gaming device, acting as an overall entry point into the experience of using the smart mobile game controller. The integrated dashboard is a part of the platform operating service. The integrated dashboard can provide a rich full screen experience when connected to the mobile game controller. When using the software service button(s) and/or connecting the mobile game controller, the integrated dashboard can be opened. The integrated dashboard can be designed to be primarily in landscape mode when the mobile game controller is connected to the computing device. Further, the integrated dashboard user interface can be configured to treat game controller input as its primary input modality. Thus, the combination of the mobile game controller and the platform operating service can feel like a dedicated end-to-end gaming system that elevates it above a core input device experience.

The integrated dashboard can aggregate all the services from native distribution (e.g., Apple Arcade), remote play (e.g., PlayStation Remote Play), and cloud game streaming (e.g., Amazon Luna). Through the integrated dashboard, the user can seamlessly launch streamed games from online resources directly inside the platform operating service using the smart service button, reducing user-friction and streamlining their ability to instantly jump into gaming content. The Integrated Dashboard allows the user to seamlessly launch games through the mobile game controller, reducing user-friction and streamlining their ability to instantly jump into gaming content. Users can leverage a universal search feature across multiple services to easily find games across the platform operating service and their computing device. User actions within the interface can be dynamically updated to be contextual and pertinent to the current device state, taking into account installation status, streaming capability, past user actions, user capabilities and linked accounts, localization, and other factors. The software service button(s) can further enhance the experience by allowing the user to quickly switch between different gaming experiences on the mobile device.

Controller Input Architecture

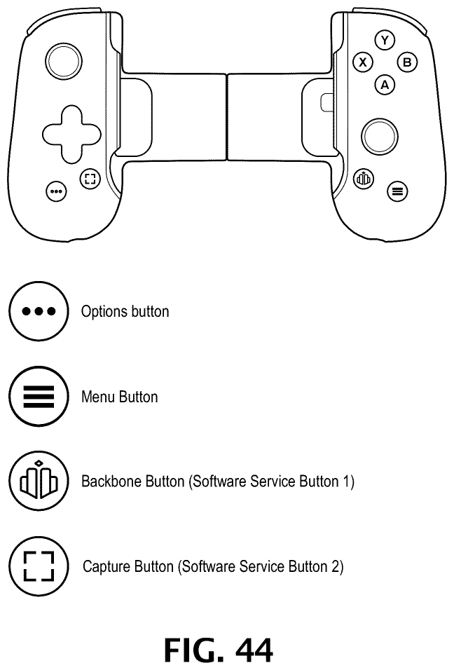

To navigate the integrated dashboard with a mobile game controller, the user interface can adjust its interaction paradigm to a focus-based approach. Some or all of the user interface components can be selectable via controller inputs. Further, in certain embodiments, some or all of the user interface can respond to touch. When a component is selected it is considered to be in focus, and generally only one component can be in focus at once. The selected component can receive additional input from the controller such as button clicks. For instance, a button may be selected by navigating the UI with the joystick and then activated by pressing the A button or touching the interface element directly. FIG. 44 is an illustration of a controller input architecture of an embodiment.

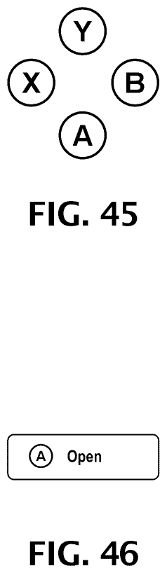

To help the user navigate the efficiently, the integrated dashboard utilizes several surfaces on the game controller. For the purposes of this button explanation, a standard ABXY button layout is used to describe the core front facing buttons (see FIG. 45). Product variations of the smart mobile game controller may use alternate symbols and glyphs while maintaining the same four-button diamond. These buttons are referred to as face buttons. In certain embodiments, the face buttons labels can be transposed as well based on the product variation; for example, the face buttons could be BAXY instead of ABXY.

Joystick and directional pad are used to adjust which component of the dashboard is in focus. Face buttons of the controller are used to move forward and back (A button will launch into the focused content, equivalent to a tap, and B button will return back to the previous content, equivalent to tapping on a back chevron/button). Remaining face buttons of the controller are used for contextual actions (X button will execute contextual action slot 1, and Y button will execute contextual action slot 2). Options button ( . . . ) is used for opening contextual actions that are associated with a menu of options. L1/R1 shoulder buttons are used for quick tab navigation, and in some cases scroll to beginning or end of a scrolling collection. Menu button (hamburger) is used for invoking the dashboard's secondary menu system (system settings, friends list, etc.). The software service button 1 is used for switching between games and to bring the dashboard back into focus. Capture button (software service button 2) is used for interacting with the capture system.

Button Hints

To make the integrated dashboard as intuitive as possible, button hints can be used to explain the various actions that may change contextually in the system. A button hint is a combination of a symbol/glyph image representing the controller button plus a short action text describing the action. Button hints can be dynamic. When the platform operating service application requests information about the Integrated Dashboard, the platform operating service returns a Contextual Action Button (CAB) that describes the button in more detail. Part of the CAB description is the button hint. The button hint is used for rendering the button (see FIG. 46). Another part of the CAB description is the action. The CAB action is invoked when the corresponding button on the mobile game controller is pressed. CAB descriptions are cached locally by the platform operating service application for faster rendering when the application loads.

When focus changes to a new component in the dashboard, any available contextual actions can be translated into a button hint affordances. This explicitly defines which button can be used to invoke each action. Since many components support more than one possible action, button hints can be grouped together in a fixed location on the screen. This provides a consistent anchor point for the user to understand what options are possible at any given time.

Dashboard Architecture

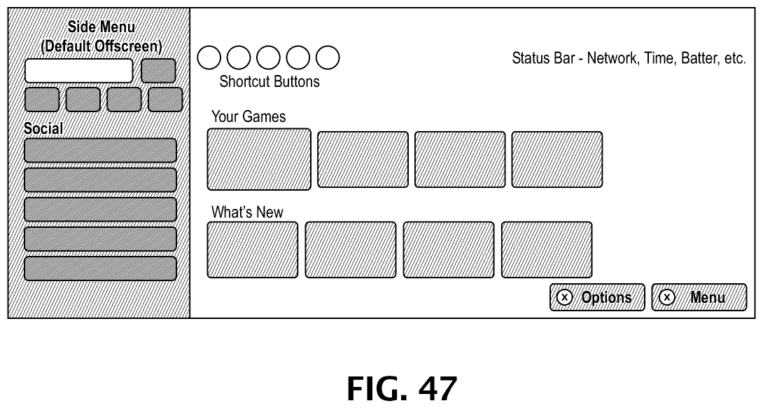

As shown in FIG. 47, the integrated dashboard can be organized into the following top-level component collections: shortcut buttons, status bar, side menu, content grid, and contextual button hints.

Regarding the shortcut buttons, in the top left, several shortcuts can be provided for easy access to commonly accessed features. For example, in certain embodiments, there can be a magnifier glass button or other button to easily bring up the universal search feature. The shortcut buttons can be invoked by pressing buttons on the mobile game controller. For instance, the menu button is activated when pressing the menu button on the mobile game controller. Regarding the status bar, since the integrated dashboard can be a full screen experience, the device operating system status can be replaced with a custom status bar. This shows common status items such as time and battery level, but also includes platform operating service features such as number of friends online.

Regarding the side menu, additional settings and features are organized into an intermittently visible side menu. The menu can be revealed at any time by pressing the mobile game controller's menu button. Regarding the content grid, content driven by the platform operating service can stretch edge to edge of the screen, and is conceptually organized into a grid. This grid of content tiles can be easily navigated with the joystick and leads to additional content pages. Regarding contextual button hints, in the lower right, any applicable button hints can be shown. Which buttons are shown depends on the content which is currently in focus. Each contextual action possible for the content will be shown as its own button, and will dynamically update when new content is selected on the dashboard.

Content Grid

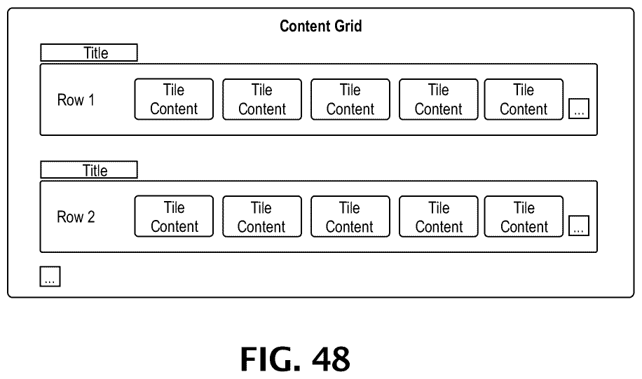

As shown in FIG. 48, content from the platform operating service is primarily presented as a grid. Content is organized horizontally into rows and within each row contains several individual items of content. Content can take many forms such as games, editorial pages, promotions, user-generated content (UGC), and gameplay highlights. Game content can have a badge which displays the game's platform. For example a game may have an App Store, Xbox or Apple Arcade badge. All data in the content grid is server driven, but the smart mobile game controller shares its identity and analytics to customize the content.

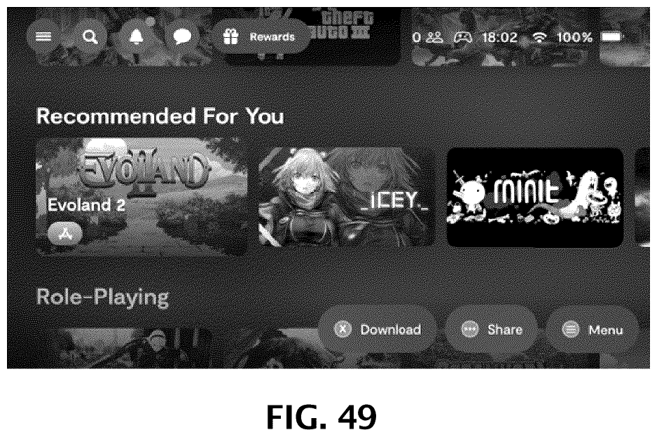

FIG. 49 is an illustration of an app store badge of an embodiment. When the content grid is in focus, one row is selected at a time. The in-focus row can be scrolled to a position which is centered vertically for clarity on what is in focus, and to ensure other floating components of the dashboard do not obstruct the content. Using the mobile game controller joystick or directional pad, the up or down directions will scroll the content vertically, switching focus to the row above or below the currently selected row. The content is scroll in row increments rather than pixel/point increments to dramatically improve the navigation efficiency. Using the mobile game controller joystick or directional pad, the left and right direction conversely will navigate between tiles of content within the focus row. Similar to row scrolling, content moves one item at a time rather than scrolling the canvas by pixel. In both scrolling modes, holding a particular direction will initially move one component at a time. As the controller input is held/sustained, over time the input event will be repeated, and at increasing intervals. The scrolling therefore accelerates over time allowing the user to quickly navigate to the beginning or end of the focused content.

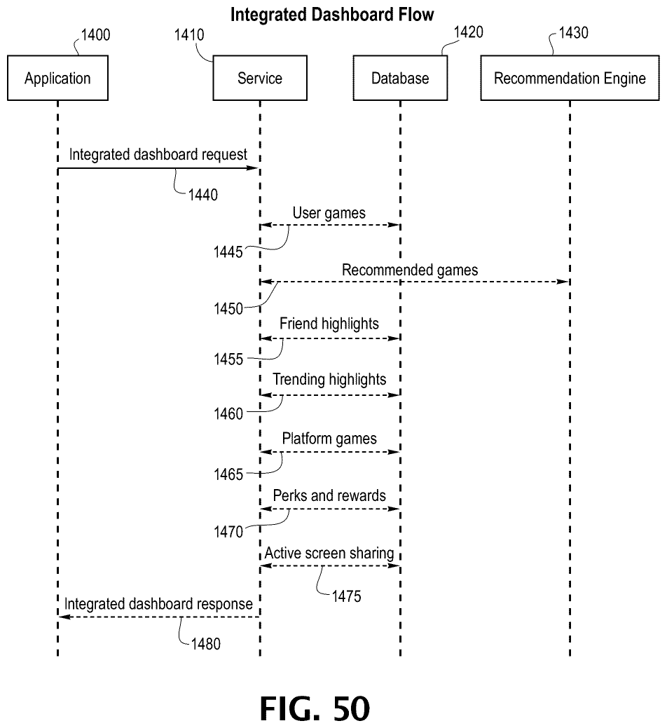

FIG. 50 is a flow diagram of an integrated dash of an embodiment. As shown in FIG. 50, an application 1400 sends an integrated dashboard request 1440 to a service 1410. In response to receiving the request, the service 1410 collects recommended games 1450 from a recommendation engine 1430, as well as user games 1445, friend highlights 1455, trending highlights 1460, platform games 1465, perks and rewards 1470, and active screen sharing 1475 from a database 1420. The service 1410 then sends an integrated dashboard response 1480 to the application 1400 based on the collected information.

Content Pages

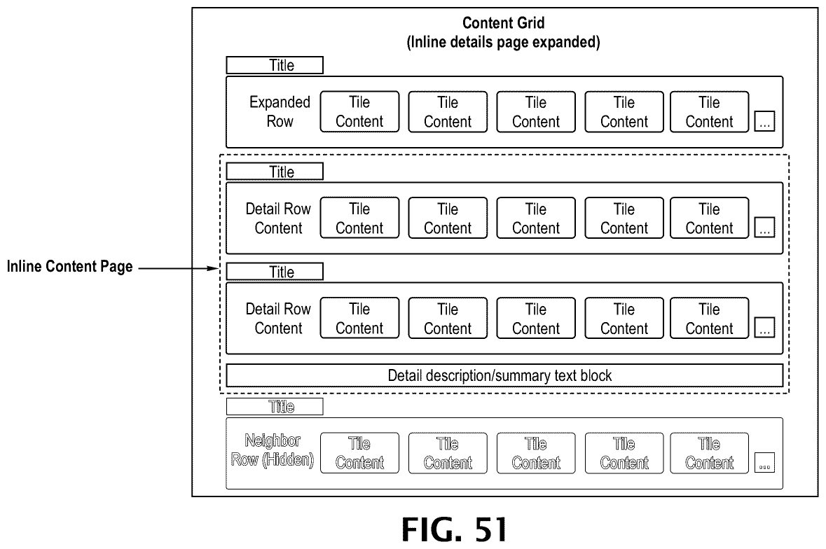

Content pages can be opened by pressing the primary face button when a particular content tile is in focus. This can expand into a detailed view for the content, which utilizes a subset of the content grid functionality, but driven by the details of the game/article, as shown in FIG. 51. Content pages can either be inline or external. With inline pages, the content can expand/zoom inline within the content grid. This is analogous to how collapse/expand chevron controls work within a text editor. Collapsing the detail page restores the original row, expanding the detail page reveals additional row content beneath the original row.

External content pages however can be presented in a separate modal which enables the page to take up the entire screen and is ideal for rich full screen experiences. External pages can be ideal when helping the user focus on a single piece of content, whereas inline pages are better suited for situations where the user wants to scroll through a collection of games, for example. Content page information can be requested from the platform operating service. In certain embodiments, the platform operating service application sends a request to the platform operating service for the detailed game information. The service responds with various metadata and identifiers such as, but not limited to, the sources of the game, screenshots, and a summary.

FIG. 52 is a content page flow diagram of an embodiment. As shown in FIG. 52, the application 1400 sends an extended game info request 1510 to the service 1410, which gathers sources (platforms) 1520, screenshots 1530, and a summary 1540 from the database 1420. The service 1410 then sends an extended game info response to the application 1400.

Additional embodiments could include content that has been favorited by the user to form a content page, content surfaced from non-gaming external apps such as Netflix or a web browser, and content not publicly available such as in application test environments such as TestFlight or Firebase.

Server Architecture

The platform operating service that powers the integrated dashboard experience essentially provides an API over a rich content database which aggregates data from multiple sources. The platform operating service application is provided with the necessary information to render the content.

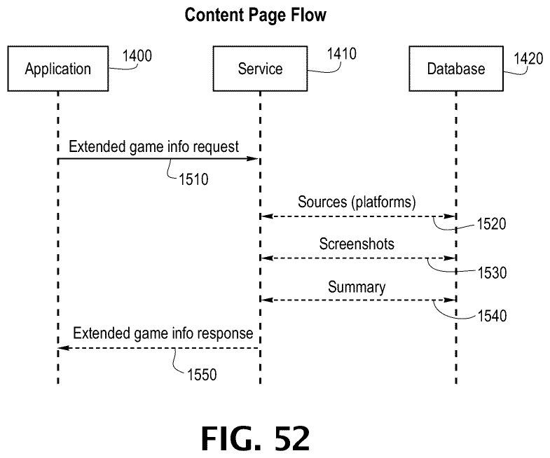

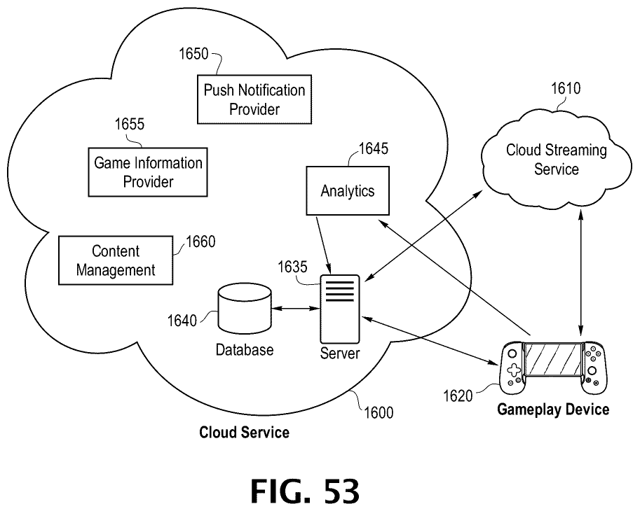

FIG. 53 is an illustration of a general client-server architecture of an embodiment. As shown in FIG. 53, a cloud service 1600 is in communication with a cloud streaming service 1610 and a gameplay device 1620. The cloud service 1600 comprises a server 1635, a database 1640, an analytics element 1645, a push notification provider 1650, a game information provider 1655, and a content management element 1660.

Games Database

The platform operating service's games database comprises a library of games across all relevant external platforms with information about each game. Each game entry can contain the information needed by the platform operating service application in order to render various functionality.

The games database serves multiple purposes within the platform operating service application, including, but not limited to: (i) assessing whether a particular game supports game controllers, (ii) providing rich media and localized metadata for the game to surface to the user, (iii) user-initiated search and filtering of games, so that users can manually determine whether a particular game is supported by the platform, discover games supported by their gameplay platform of choice, learn more about a particular game, and find highlights and screenshots of other users playing the game, and (iv) surfacing game suggestions to users on the Integrated Dashboard, both through editorial curation and algorithmic personalization (see below)

This games database can be kept up-to-date through both automated consistency checks that compare the database's content against content platforms' own databases, and in the cases of platforms that do not provide such information, manual intervention as the result of user reports of missing or incorrect games. This manual intervention can be important given the fragmented availability of this information across multiple platforms. Human intervention usually occurs as the result of user reports, such as app reviews or customer support requests, but user search and launch analytics can be used to determine games that users wish to play but have not yet reported. The games surfaced from these queries are tested to ensure they support game controllers and are then marked as such in the database.

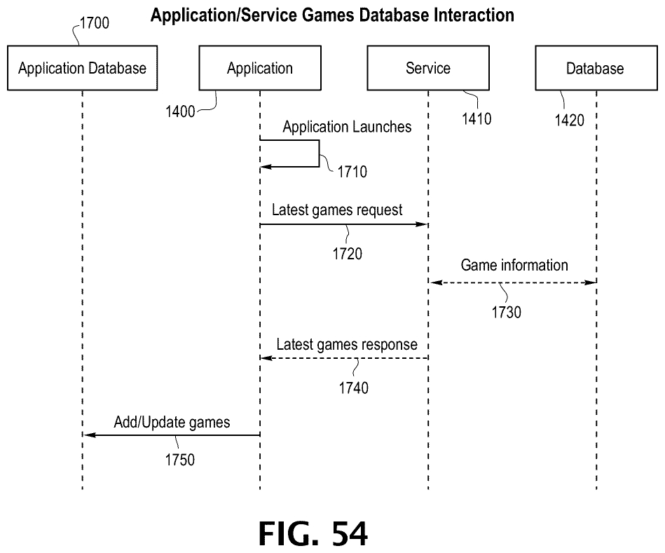

FIG. 54 is a flow diagram that shows application/service games database interaction. As shown in FIG. 54, after the application launches (act 1710), the application 1400 sends a request 1720 for the latest games to the service 1410, which gets game information 1730 from the database 1420 and responds to the application 1400 (act 1740). The application 1400 then adds/updates games to the application database 1700 (act 1750).

Analytics

As the user interacts with the platform operating service application, analytics can be sent to the platform operating service. The platform operating service can use these analytics to enhance the user experience by personalizing application content. In some embodiments, this can be achieved by customizing the data returned in the application's Integrated Dashboard request.

The flow of analytics can start on the gameplay device and can be sent to the platform operating service's analytics service. The analytics service can forward the events to several destinations. One destination can be a recommendation engine. This engine is used to recommend games to a user based on their activity and possibly other user's preferences. Another destination can be an analytics store. The analytics store is used to build information the platform operating service can use when generating Integrated Dashboard content.

Examples of customized content include prioritizing rows based on usage, prioritizing rows based on the age of the content, hiding items the user may already have installed, displaying highlights based on views or reactions, and driving behavior in the application, such as prompting the user for a review after a custom set of criteria is met.

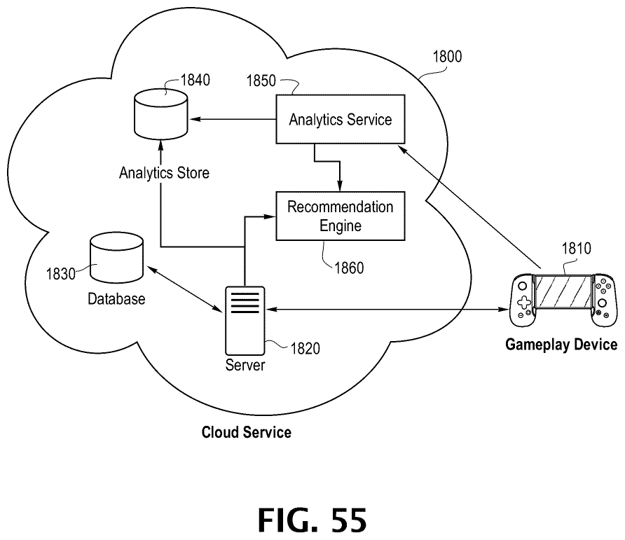

FIG. 55 is an illustration of an architecture that can be used for analytics. As shown in FIG. 55, this architecture comprises a cloud service 1800 in communication with a gameplay device 1810. The cloud service 1800 comprises a server 1820, a database 1830, an analytics store 1840, an analytics service 1850, and a recommendation engine 1860.

Personalization

The following are examples of content personalization. The mobile game controller-based launch analytics and installed game detection can be used in conjunction with the games database and additional user context, such as the user's device state, information provided by the device operating system, and information from accounts on external or native platforms, to produce game recommendations as part of the integrated dashboard. Viewing analytics of user generated content can also be fed into the recommendation engine to influence game and content recommendations. Games can also be organized into groups that can be displayed as rows on the Integrated Dashboard. The personalized dashboard can rank the rows based on whether the row has been seen or not, to additionally surface new and unseen content. The platform operating service application can report to the cloud service the list of games that it has detected. The platform operating service uses this information to provide lists of games based on a platform. For instance, if the user has Playstation Remote Play installed they may see a row specifically for Playstation games. The platform operating service may enable the user to maintain friendships with other users, allowing the server to surface friend activity and relevant content such as game highlights and suggestions from friends. Game tiles can also be customized with information about other users that are playing a particular game.

Game tiles can be associated with actions based on specific accessory-device context that are relevant and customized to the user and current device state such as “Download”, “Play Instantly”, “Add or Hide from Library”, “See Details”, “Ways to Play”, and more. Content can also be segmented based on product SKU, to surface games, how-tos, perks and benefits, and other product specific content, such as Playstation titles and content for the Playstation co-branded SKU. The server can know the user's configured language and can provide localization specific content, including content filtering and availability, language, media and image variation, ratings, and more.

Launching the Application with Software Service Button

In some embodiments, the user can press a software service button in order to launch the platform operating service application. In certain embodiments, the application can take the user into an onboarding and setup flow, adjust computing device permissions, or go straight into the integrated dashboard. When the integrated dashboard is shown to the user, it can receive data from the platform operating service to display user personalized content; alternatively, it can display curated content. The user can use the mobile game controller to navigate through the integrated dashboard where they can launch games, view clips and highlights, adjust settings, or use any feature part of the integrated dashboard.

User Journey

The following is an example of a user journey: (1) connect mobile game controller to the computing device, (2) press software service button, (3) latest personalized content shown in dashboard, (4) navigate to desired gaming experience, (5) launch into the game.

### Example Implementation

In certain embodiments, the platform operating service app can request game information from the platform operating service's game database in order to be cached locally. This reduces load times and subsequent network bandwidth requirements to enhance the user experience. The local games database cache provides data used throughout the platform operating service application including the rendering of games in the Integrated Dashboard as well as game search and discovery.

In certain embodiments, the platform operating service application can provide metadata, including detected games, to the platform operating service so that the platform operating service can generate and return a personalized dashboard, currently represented by collections of related content organized into rows. A row may contain popular games, trending content, device specific information, or simply a list of games. Further, some rows may contain rendering instructions for the platform operating service application to render with specialized logic not otherwise available on the Integrated Dashboard. One example of such an instruction is known as “User Games”—when the platform operating service application encounters this instruction from the platform operating service, it renders tiles for all games the platform operating service application knows to be installed on the computing device.

The platform operating service application can render the integrated dashboard. The user can navigate the integrated dashboard using any combination of input from the mobile game controller and touch gestures. A user can also use the mobile game controller or touch gestures to open or launch a tile, after which the application can perform a designated action, such as launch a game, open a rich media experience, visit a website, view another aspect of the application, or launch a game or experience within another application on the computing device.

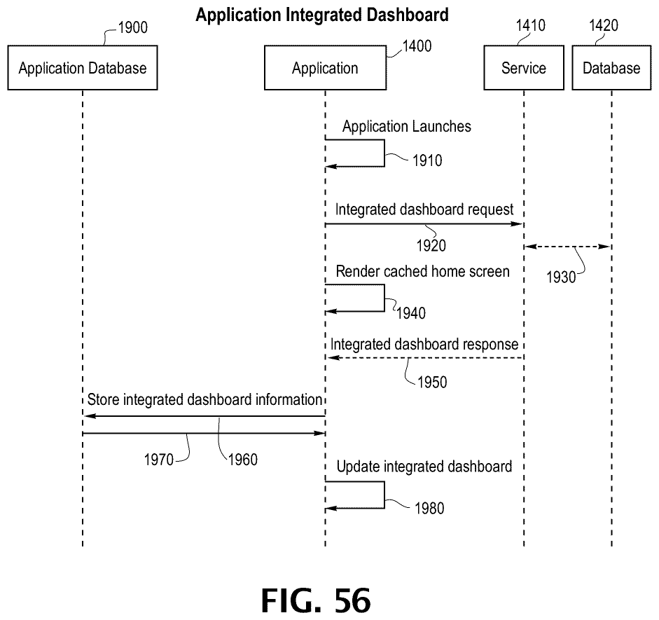

FIG. 56 is a flow diagram of an application integrated dashboard of an embodiment. As shown in FIG. 56, after the application 1400 launches (act 1910), the application 1400 sends an integrated dashboard request 1920 to the service 1410, which communicates with the database 1420 (act 1930). The application 1400 renders a cached home screen (act 1940), and the service 1410 returns an integrated dashboard response 1950. The application database 1900 and the application 1400 exchange stored integrated dashboard information (acts 1960, 1970), and the application 1400 updates the integrated dashboard (act 1980).

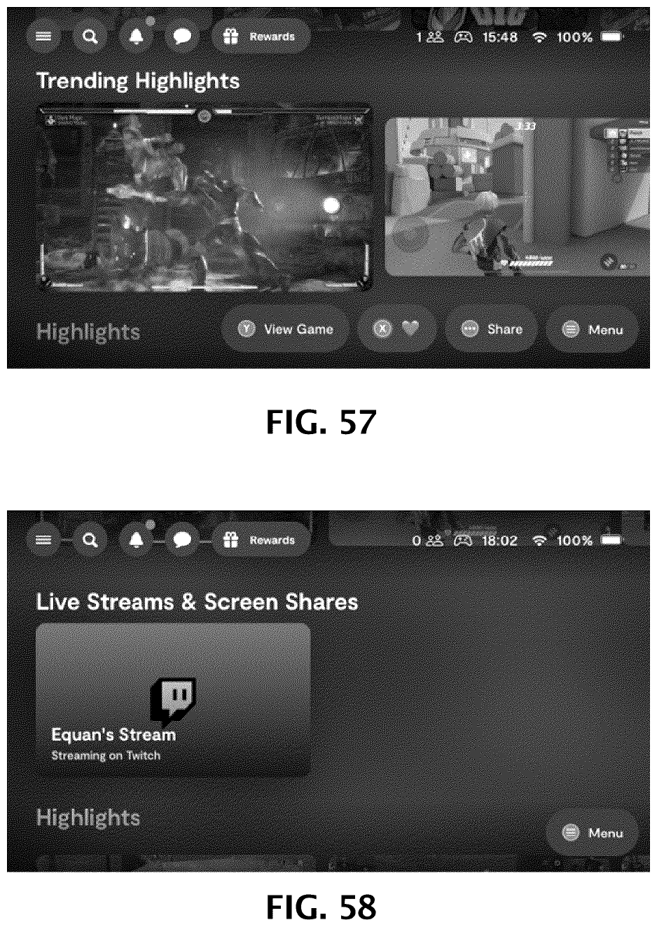

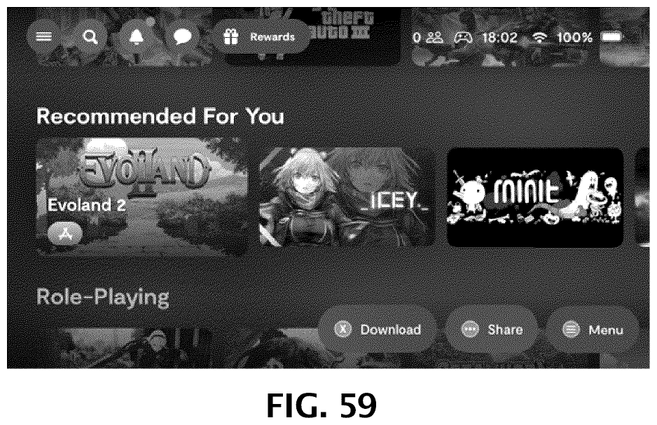

Additional embodiments can be launching content on an external device, launching videos, opening web sites, viewing live streams, other applications or other functionality within the application. Additionally, the platform operating service application can also be launched when the controller is attached to the computing device. FIG. 57-59 are screen shots that show examples of personalized content.

Viewing Available Installed Content

In some embodiments, the user can open the platform operating service application through pressing a software service button or launching from the device operating system. The user can be taken to the Integrated Dashboard to see what content is available to use within the application. The Integrated Dashboard can surface content that can be played, as well as recall and quickly launch games the user had previously played.

The following is an example user journey: (1) user opens the personalized dashboard by pressing the software service button, (2) the platform operating service compares its understanding of installed applications with a list of supported games, and (3) the user sees a list of supported games on the personalized dashboard.

### Example Implementation

In certain embodiments, the platform operating service can automatically determine what games are available to play by leveraging a number of data sources in the underlying system and comparing it to a curated list of games known to be compatible with the platform operating system. This system can also preserve user privacy by only collecting and storing information about software packages known to be games, thus limiting the data available to cloud services to only the details necessary for such a collection.

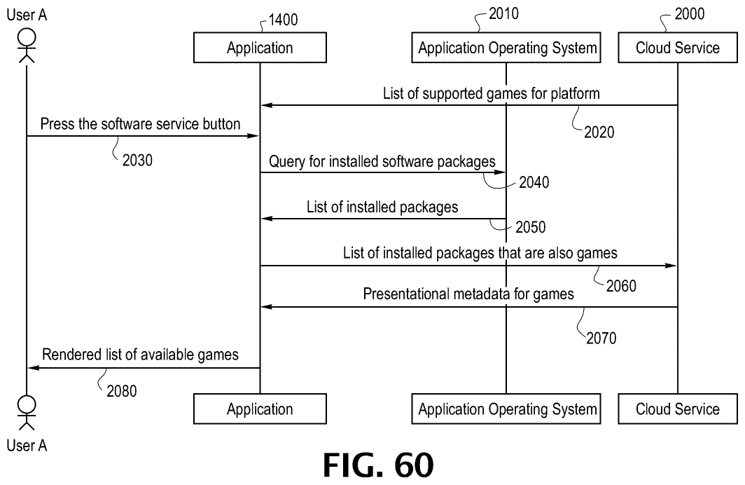

FIG. 60 is a flow diagram that illustrates an embodiment. As shown in FIG. 60, a cloud service 2000 sends a list of supported games for the platform to the application 1400 (act 2020). After the user presses the software service button (act 2030), the application 1400 sends a query to the application operating system 2010 for installed software packages (act 2040), and the application operating system 2010 returns the list (act 2050). The application 1400 then sends a list of installed packages that are also games to the cloud service 2000 (act 2060), which returns presentational metadata for games (act 2070). The application 1200 then sends a rendered list of available games to the user (act 2080).

Further, the platform operating service can receive a list of content that is supported for the gameplay device. When the user presses the software service button, the platform operating service application can query the application operating system for installed software packages, as well as restore a cached list of applications previously detected on the gameplay device (in case, for example, the computing device operating system does not return a complete list of installed software packages). The software application can then cross-reference this list of known available content with the cloud service-provided list of supported content, and send this list to the cloud service. The cloud service, which can store metadata for all supported games, is then able to send down a customized set of metadata for the games to render, for example, on the personalized dashboard for the user to view and launch available content.

In some embodiments, the application can retrieve and/or store the last time content was detected, and then send the list of installed content to the server in order of this last detection time. This additional functionality can be used to sort the rendered list of available content to the user so that more recently-used content is easier for the user to see and launch.

Additional embodiments could include non-game media being cataloged and launched from the application, games that are not locally installed on the gameplay device but are still available to play using the gameplay device (see below section).

Another embodiment could be the application not sending such information to the cloud service in favor of rendering a list of available content using locally-stored information. One embodiment can be to allow the user to determine whether an installed application can be played with the gameplay device and maintain this user-curated list of supported content. The benefit and use case of such embodiment(s) can be to enable the user to view available content available when the cloud service is unavailable, for example, because the user does not have an network connection.

Another embodiment could include being able to add or remove content from this list. Users can create a list of their favorite games that they can quickly access when opening the application.

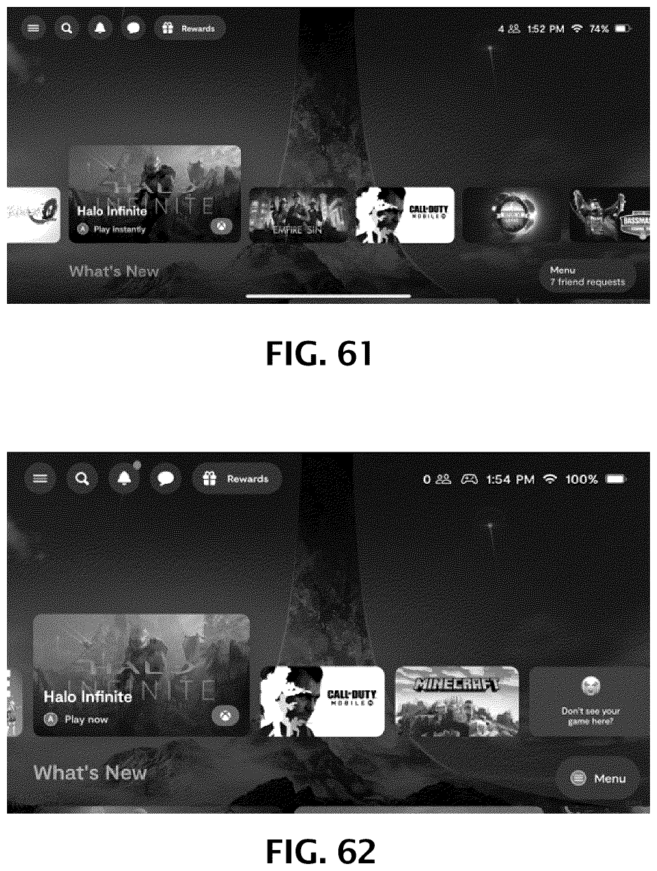

FIG. 61 is a screen shot showing an example of recently-played games.

Playing Content Available on an External Gameplay Service

In some embodiments, the content listed in the Integrated Dashboard may be available to stream from an external service within the platform operating service application. The user is able to view details about the content and launch the content without leaving the application. The user can go between the application and the external content by using the software service buttons and continue to leverage platform operating service features.

The following is an example of a user journey: (1) the user opens the Integrated Dashboard by pressing the software service button, (2) the user navigates the Integrated Dashboard using the smart mobile game controller and finds a game on the Integrated Dashboard that is available on an external gameplay service, (3) the user presses a button on the smart mobile game controller to launch the game, (4) a browser is opened inside of the platform operating service application, (5) the user plays the game without having to leave the application, leveraging the same smart mobile game controller features as installed games, such as live streaming and recording of gameplay, including flashback recording, rich presence notifications, and controller-integrated real-time audio chat), and (6) the users presses the software service button to exit the game and return to the Integrated Dashboard.

### Example Implementation

To determine what games are available to the user, the platform operating service application can surface a prompt to the user to authorize external gameplay services to share gameplay history with the platform operating service. If a user proceeds with the prompt, the platform operating service can then launch the user into the Account Linking functionality.

The platform operating service games database can store mappings between the streaming services' identifiers and the platform operating service identifiers, which allows the service to identify which games from the user's gameplay history are playable on the platform operating service, and then to surface curated metadata and imagery for playable games on the personalized dashboard. These games can be intermingled with games installed on the gameplay device to provide the user a seamless experience between games on external gameplay services and those available on the platform operating service. Further, the platform operating service can identify and include games the user played on the external gameplay platform, but not on the platform operating service; this allows the platform operating service to prompt users to continue games they were previously playing elsewhere. FIG. 62 is a screen shot that illustrates this embodiment.

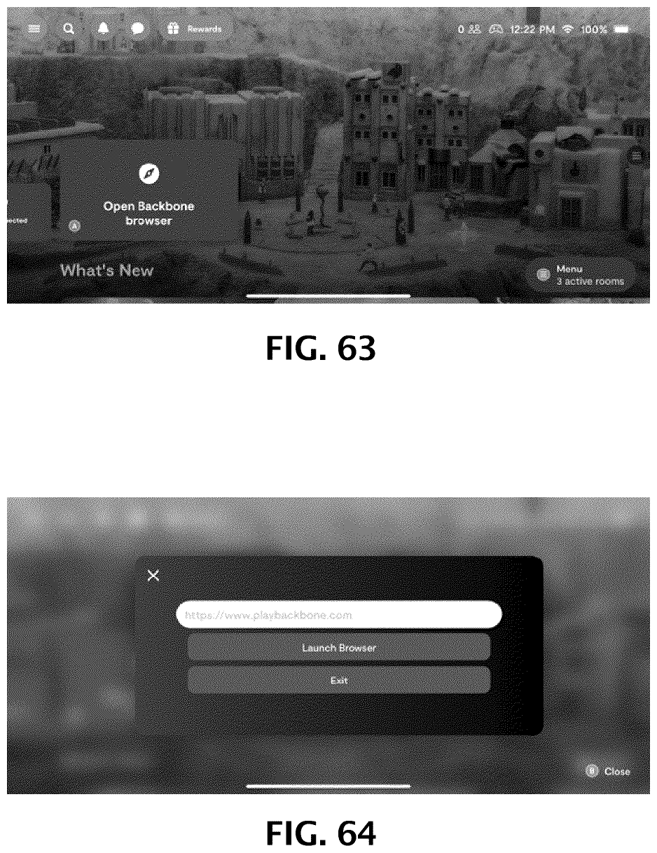

The platform operating service can specify how to launch the game on the external gameplay service. In some embodiments, the client can be instructed to launch a browser to a specific resource on the external gameplay service. It is also possible to launch the computing device browser to view details about the game specified, or to launch an embedded experience showcasing games available on the external gameplay platform. As example of this is shown in the screen shots in FIGS. 63 and 64

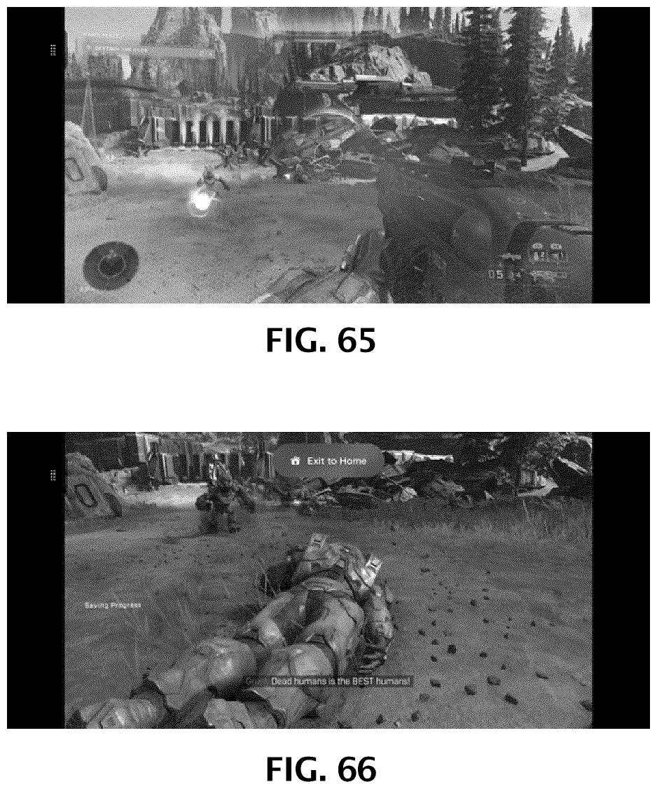

Users can also direct the platform operating system to open the browser to a specific destination, which allows the user to browse websites in full screen and launch games not provided on the personalized dashboard, or utilize external gameplay services not directly supported by the platform operating service. FIG. 65 is an example implementation of the browser rendering an external gameplay service, in this instance, Xbox Cloud Gaming, and FIG. 66 is an example implementation of the browser rendering an external gameplay service, in this instance, Xbox Cloud Gaming, with a touch-based exit button. The exit button could be tapped by the user to exit the content viewing experience or could indicate to the user that they can use the software service button to exit the experience.

The browser can be presented on top of the personalized dashboard interface. The platform operating service application can configure the browser to support inputs from the mobile game controller, so that there is no need for any platform-specific intervention for the game controller to support play.

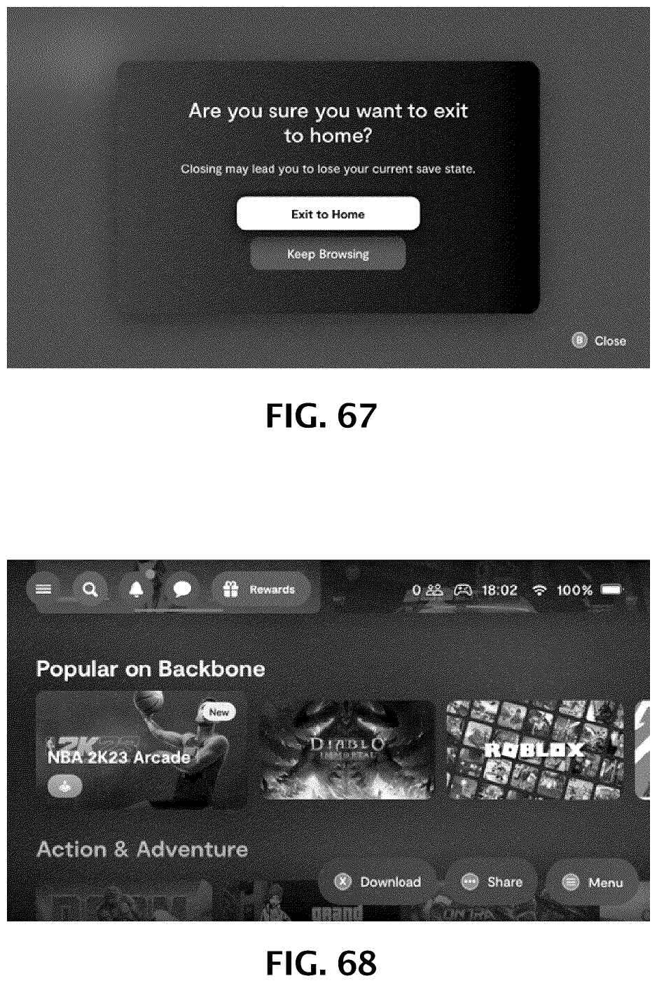

The browser can allow users to return to the personalized dashboard by pressing the software service button, and then confirming their intention to exit (see FIG. 67). This confirmation dialog can be provided because sessions on external gameplay services often take considerable time to initialize. Using the software service button, which can be otherwise unavailable for games on external gameplay services, enables the platform operating service application to support all standard mobile controller inputs in a full-screen immersive experience while still enabling the platform operating service application to suspend or end the experience when a user requests to do so.

Additional embodiments could include external computing devices streaming games into the application, games available within the platform operating service, or games available within a specialized browser or content rendering mechanism. This invention could also enable users to launch and/or play games renderable by the browser functionality that are included with or downloaded into the platform operating service application, as well as launch and/or play games within a browser application external to the platform operating service. Another embodiment could also be launching into an external application for the purpose of enabling the user to play games. Additional embodiments can leverage other embedded content runtime to stream games into the application.

Content Discovery

In some embodiments, the Integrated Dashboard can provide the ability for users to discover content personalized to them from the platform operating device. Analytics and other metadata are leveraged to surface desirable content. By using the mobile game controller, the user can navigate through the personalized content, view details on the content, and play/install content directly to their computing device.

The following is an example of a user journey: (1) the user opens the Integrated Dashboard by pressing the software service button, (2) the user navigates integrated dashboard using the mobile game controller, (3) the user sees a curated and personalized list of games based on application analytics, (4) for native games, the user can download the game via single button push using the mobile game controller, (5) for installed native and streamable games, the user launches the game with a single button push using the mobile game controller, and (6) the user is proved with additional options specific to content type and context

### Example Implementation

Game discovery in the platform operating service application depends on several components. The first component is the games database. When the platform operating service application is launched the client requests and synchronizes data from the platform operating service games database. The games database is stored locally on the computing device in order to provide fast lookups and reduce user bandwidth requirements and usage.

The second component is the Integrated Dashboard. Another phase of the platform operating service application launch is to query the platform operating service for the updated Integrated Dashboard information. This information includes popular games as well as other information the user might find relevant based on analytic data and games detected on the computing device.

Using the combination of the information in the games database and collected user data, the user can be provided relevant contextual actions allowing them to install a new game, launch an existing game, view more information about a game, manage game visibility within the interface, and more.

In certain embodiments, the Integrated Dashboard can begin playback of rich media content without user intervention. For example, if a user does not change their selection of a specific tile, the Integrated Dashboard could begin playback of an associated video within the tile, or in another designated user interface element. Such an associated video could be supplied by the platform operating service cloud service, or retrieved from an alternative source, and could be played back using a content viewer embedded in the relevant user interface element. This could enable the user to engage in the content more easily, better educate the user about the value of a particular piece of content, or encourage the user to launch the content.

Additional embodiments could include games installed on other external computing devices, game favorited on computing devices web browsers (see FIG. 68).

Content Search

In some embodiments, the platform operating service application can provide users a way to search for content installed on the computing device, content provided by external providers, or content that has been stream enabled by external content providers. Users can use the mobile game controller or leverage touch controls to navigate the user interface. Upon finding a game, the user can view details on the game from the local storage version of the games database, download or play the game.

The following is an example of a user journey: (1) the user navigates to the dashboard with the mobile game controller, (2) the user selects the search button by pressing a button on the mobile game controller, (3) the user is presented with a list of games, (4) the user presses the App Store button to see only games available in the App Store, (5) the user installs the game from the app store, and (6) the user launches the game.

### Example Implementation

Game search is another feature that uses the games database stored on the phone. When the user presses the search button a view is presented that contains all of the games known to the platform operating service application. The list can be searched by title or the list can be filtered by selecting a platform from the list. The games database contains all of the information needed when the user selects a game from the list.

The list of games known to the application is synchronized with the service during application launch. Refer to the games database section for details about application/service synchronization.

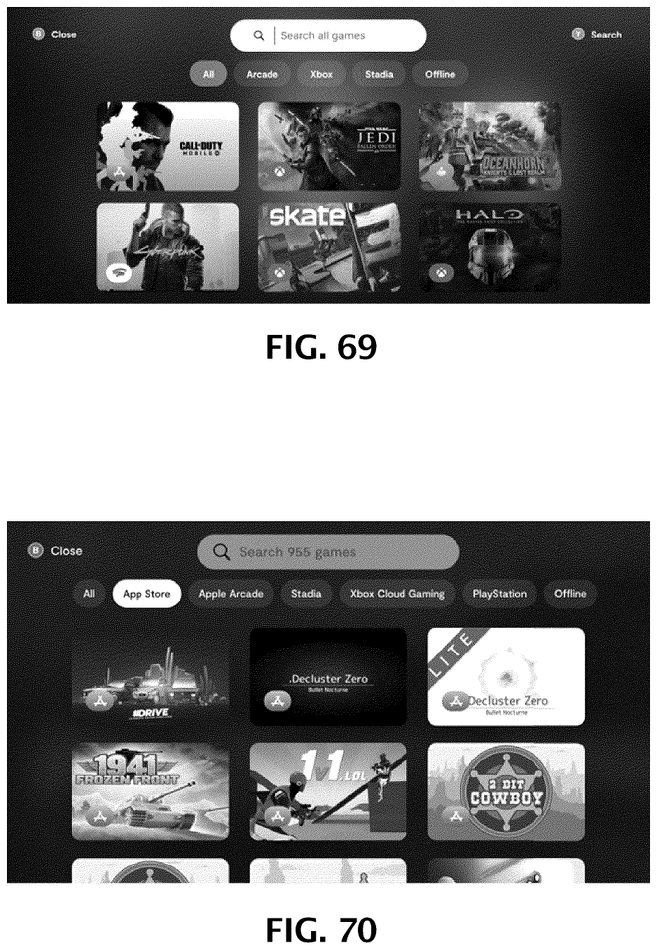

Additional embodiments could include searching through all associated computing devices where the platform operating service application is installed, and any content that can be detected have been played before (see FIGS. 69 and 70). Depending on the SKU of the mobile game controller, the search can be tailored to show different items in priority that work better with the mobile game controller or adjust the software service buttons and software service indicators.

Account Linking

Account linking gives users the ability to play games without having to leave the platform operating service application to re-authenticate with external cloud gameplay services. Further, it enables the platform operating service application to detect, suggest, and launch games on external cloud gameplay services without additional user intervention.

The following is an example of a user journey. (1) the user opens the platform operating service application by pressing the software service button, (2) the personalized dashboard recognizes the user has not linked their account on an external platform and renders a prompt to link their account on the platform with their platform operating service account, (3) the user uses the smart mobile game controller to launch into the prompted account linking flow, (4) the user enters their external platform login credentials (on successful connection, the platform operating service application returns the user to the personalized dashboard), and (5) the user starts a cloud gameplay session without the need to enter their credentials.

### Example Implementation

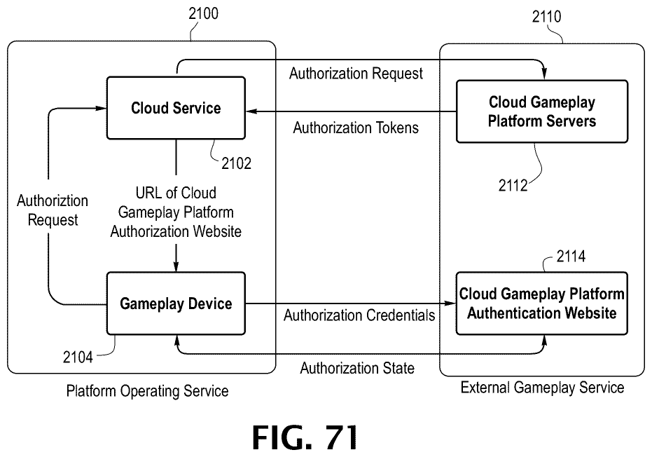

Account linking leverages the interoperability of several components: the gameplay device, the cloud service, the cloud gameplay platform servers, and the cloud gameplay platform authentication website. FIG. 71 is an illustration of a platform operating service 2100 and external gameplay service 2110 of an embodiment. As shown in FIG. 71, the platform operating service 2100 comprises a cloud service 2102 and a gameplay device 2104, and the external gameplay service 2110 comprises a cloud gameplay platform service 2112 and a cloud gameplay platform authentication website 2114.

In certain embodiments, Account Linking works as follows: (1) the platform operating service application requests authentication with an external service, (2) the platform operating service responds with a URL for the user to enter their credentials, (3) the platform operating service application renders the credential website in an embedded web browser, (4) the user enters their credentials and authorizes the platform operating service to access their information, and (5) a token representing this authorization is stored in the platform operating service, and the user's authentication state is securely stored within the platform operating service application.

The platform operating service stores the authorization state and can recognize whether the user has already authenticated with the external cloud gameplay servers, the platform operating service leverages a dynamic button mapping capability to enter this account linking flow only when it is relevant to the user. Otherwise, the platform operating service can specify either to hide the prompt or instead to show a confirmation that the platform has been successfully linked.

The approach allows the platform operating service application to request authentication with an arbitrary number of services without additional client changes. Since the user's authentication state for the cloud gameplay platform is stored within the platform operating service application, launching the embedded web browser into a cloud streaming gameplay experience with that platform can be retrieved on every game launch so that the user does not need to reauthenticate.

Additional embodiments could be synchronizing any authentication state or authorization credentials from the platform operating service application to the cloud service, or to store all credentials and authorization locally on the gameplay device.

Content Discovery Through Notifications

In some embodiments, the platform operating service can surface notifications to users when other users of the platform are viewing/playing content. The notifications can provide a discovery mechanism for content within the platform operating service application. Users can use the mobile game controller or touch controls to open details of the game and launch/install the game on their computing device.

The following is an example user journey: (1) a friend of user starts playing a game with smart mobile game controller, (2) the user receives notification of friend activity, (3) the user presses smart service button, (4) the integrated dashboard opens and leads user to game detail page, (5) the user downloads the game via single button push, and (6) the user launches the game with a single button push.

### Example Implementation

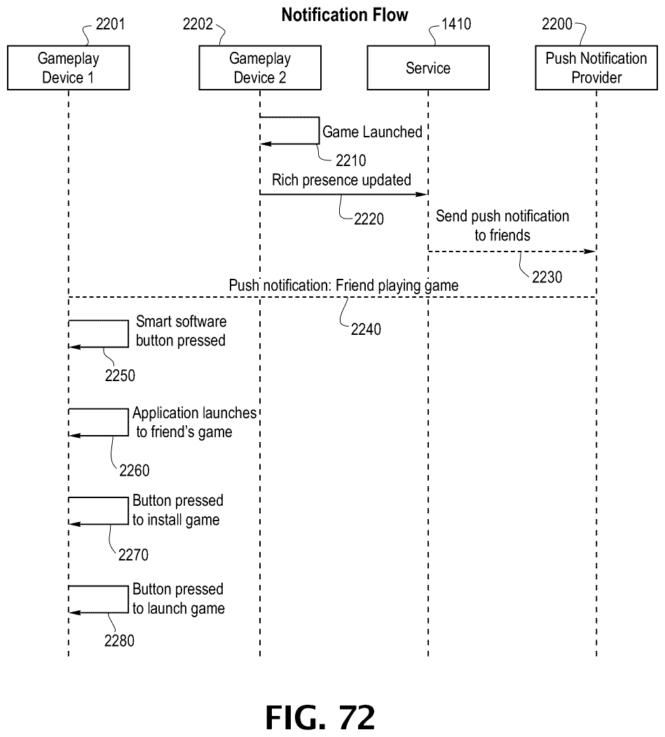

FIG. 72 is a notification flow diagram of an embodiment. As shown in FIG. 72, after “Gameplay Device 2” 2202 launches a game (act 2210), “Gameplay Device 2” 2202 sends a rich present update to the service 1410 (act 2220). The service 1410 sends a request to push notification to friends (act 2230) to the push notification provider 2200, which sends the push notification (act 2240). “Gameplay Device 1” 2201 then presses the smart software button (act 2250), and an application launches to the friend's game (act 2260). Then, the button is pressed to install the game (act 2270), and the button is pressed to launch the game (act 2280).

When a user starts playing a game, the platform operating service application sends a request to the platform operating service to update their presence. User presence contains rich context about which game they are playing. The platform operating service will then generate and send push notifications to friends letting them know that a friend of theirs is playing a game.

The friend that receives the notification can interact with the push notification using the software service button. In this case the software service button can direct the UI to open detailed information about the game that their friend launched. From there the user can view more information about the game, install the game if they don't already have it or launch the game to join their friend.

Additional embodiments could include sending notifications when friends are playing games that could be played on the smart mobile game controller, whenever an associated friend is streaming, or sending notifications to users on other surfaces besides the computing device, such as a user's television or smart appliance.

Social Play Through Content Tiles

In some embodiments, the platform operating service can surface which friends of a user has played a certain game to the Integrated Dashboard. As the user navigates the content grid of the Integrated Dashboard with the mobile game controller or touch controls, the specific content tile may display N number of friends that have viewed/played the content. Users can use the mobile game controller or touch controls to open details of the game and launch/install the game on their computing device.

The following is an example of a user journey: (1) the user presses opens the Integrated Dashboard by pressing the software service button, (2) the user navigates personalized content on integrated dashboard using the smart mobile game controller, (3) the user sees a game which friends also play, (4) the user opens up game details page, (5) the user downloads the game via single button push, and (6) the user launches the game with a single button push.

### Example Implementation

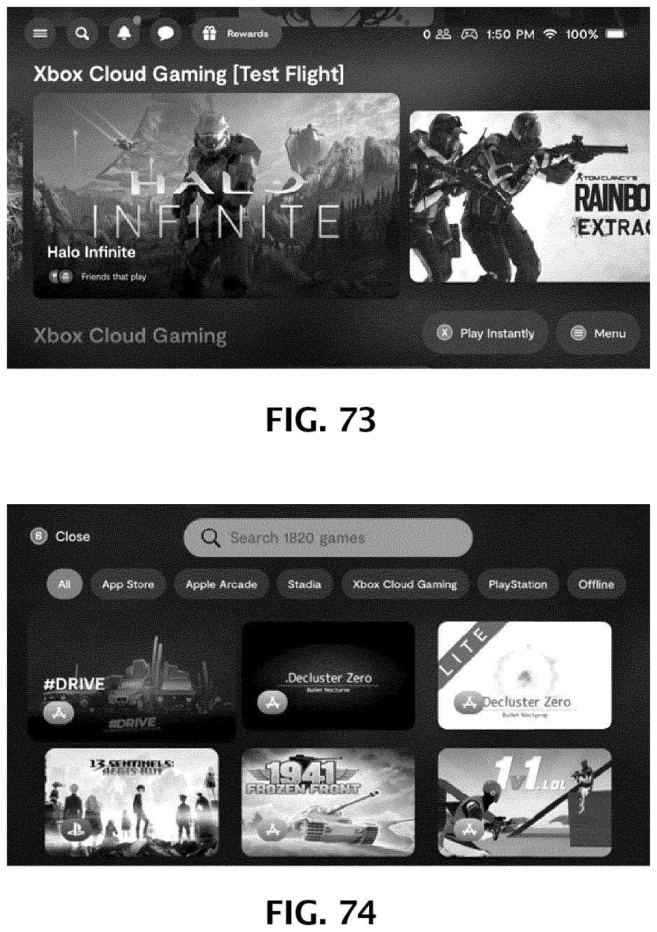

Users in the platform operating service application can search for friends and add them at any time. The list of friendships is then stored in the platform operating service. Analytics track events in the application. Each time a game is launched, the platform operating service application registers an analytic event with the platform operating service. The combination of these concepts is what powers Friends that Play. When the platform operating service application queries for the Integrated Dashboard tiles, the platform operating service does a query for friendships. The server uses the list of friends to then query if any friends have played a given tile. The list of friends who have played a game is then returned to the platform operating service application for presentation to the user. FIG. 73 is a screen shot of a Friends that Play feature of an embodiment.

Searching for New Content

In some embodiments, the Integrated Dashboard can provide users the ability to search for new content both native and external to the computing device through the platform operating service. Users can use the mobile game controller or touch controls to type search terms to find content. Upon finding any content, the user can use the mobile game controller or touch controls to open details of the content and launch/install the content on their computing device.

The following is an example user journey: (1) the user plugs in computing device into mobile game controller, (2) the user presses software service button, (3) in the integrated dashboard, there is a clearly visible search button, (4) the user enters text into the search prompt, (5) the user finds the game and opens its detail page, (6) the user downloads the game via single button push, and (7) the user launches the game with a single button push.

### Example Implementation

Searching for a new game can leverage the games database on the computing device. The platform operating service application keeps the local version of the games database up to date each time the platform operating service application is launched by requesting the most recent information from the platform operating service. Each game in the database contains information that allows the platform operating service application to install or launch a game. When the user opens the search view, the list of games is rendered. The user can use the mobile game controller to scroll through the list or select one of the filters to only show games from a particular source.

Additional embodiments could include searching the games database for games that could be played with any associated computing device and device operating system, searching through external cloud streaming providers, or searching the list directly from the cloud service. Another embodiment could include searching a custom list provided locally or from a platform operating service without caching the results each time. The content surfaced can be for any form of content even if it not controller supported. FIG. 74 is a screen shot of an example game search view.

Per-Product Customization

When the mobile game controller is plugged into the computing device, the unique product identifiers are registered with the platform operating service. This in turn, adjusts the suitable content which should be shown in the dashboard. For example, in the case of a product designed for a particular cloud gaming service, the content delivery system will prioritize games from that service to help get the user started.

In addition, the product version also affects the button symbols and hints used throughout the platform operating service application. So, if the version of the smart mobile game controller implemented a different layout of its face buttons, for example different than ABXY, the buttons in the app would dynamically update to reflect the currently attached controller. Lastly, the smart mobile game controller implements a custom vendor string to enable third party apps and games to detect the controller and adapt their own UI as necessary.

Additional embodiments could be changing software service indicators to match indicators while playing different cloud streaming games, software service indicators to match external content indicators (eg red lights on external game controllers)

In-App Button Functionality

Additional software service buttons on the mobile game controller can be designed to enable unique platform operating service functionality. The implementation and usages are described below.

Example Software Service Button

The software service button on the smart mobile game controller provides a high degree of flexibility, and its function is contextual, based on the state of the system. When the platform operating service application is not active, the button can enable launching the app into the foreground. The process of launching the platform operating service triggers synchronization between the system and application to update the dashboard with any game context changes and provide updated play history with contextual actions. The service is then able to retain and utilize the contextual information on subsequent launches to drive additional personalization of the Integrated Dashboard content.

When the software service button is pressed while the software operating service is active, the platform operating service decides the action based on the state of the Integrated Dashboard. In the case where there is no an interactive gaming session within the Integrated Dashboard, pressing the button switches back to the previous gaming context (e.g., previous entry on the task stack). However, when in an interactive gaming session, the button can instead act as a signal to manage the session. Usually this is to invoke some kind of system level menu.

Lastly, some games have their own concept of a home button, and menu functionality around the button. The software service button on the smart mobile game controller also implements a secondary gesture, where holding the button longer maps to the game or service's home button functionality, and shorter presses map to the platform operating service application. This allows for short presses to do the smart Integrated Dashboard behavior, and long presses to interact with the game/service.

Example Software Service Button—Capture Button

The capture button is another software service button on the smart mobile game controller. Its function is generally focused on audio/video capture, but similar to the other software service button, its behavior is contextual based on the state of the system. The capture button can be designed to support three primary gestures: (1) single press, (2) double press (i.e. two presses in quick succession), and (3) press and hold. The nominal capture button behavior is to start/stop recording with a single press, and take a screenshot with press and hold. The user can then change the behavior of the capture system as they desire. For example, the user may opt to enable Smart Recording where the capture service continuously records gameplay into a short circular buffer, and produces video clips on demand. In this case, short press would enable/disable the feature, double press would create a clip, and press and hold would take a screenshot.

The capture button is limited to clip recording. Through the integrated dashboard, a user can also take advantage of screensharing and live streaming features. With the architecture of the capture service allowing multiple destinations, it is possible to configure the button gestures to control multiple recording functions. For example, while live streaming, you could map the gestures to: single press (start/stop clip recording), double press (save a clip), and press and hold (end live stream). This setup would allow the user to simultaneously record clips while also streaming their gameplay to a live streaming service. Screensharing is very similar and so any remote broadcasting feature could be plugged into one of the capture gestures easily.

Contextual Interaction with Notifications

Another aspect of the platform operating service is that it can have the ability to surface notifications to the user. If the user presses the software service button while a notification is active on screen, the platform operating service application can combine the press with the notification context, to bring up the relevant content in the dashboard or execute the relevant action. For example, if the user is notified that another user on the platform invited them to participate in a party voice chat, the user can press the software service button to quickly join the chat.

Similarly, when a new video clip is recorded, a notification will appear. You could use the software service button to immediately view or edit the clip. In this case, the smart service buttons work together to allow for intuitive control of the system using just the controller.

The implementation of the contextual interaction with notifications is agnostic of whether the device operating system supports button interaction with notifications, or whether the platform operating service (“the app”) is even running on the device when the software service button is pressed. This is done by the fact that, on application launch, the device operating system will check what the last relevant displayed notification was, and execute the appropriate action. Therefore, as long as it is possible for the device operating system to support an application launch (i.e. of the platform operating service), this behavior is possible.

Mute

The options software service button can also be used while in a party or a room. Double tapping on this button will mute if unmuted or unmute if muted if there is an active voice session.

Customization

The software service buttons can also be customized. For instance, the buttons could be mapped to start or join a party, send messages or invoke other functionality in the platform operating service.

Setup and Onboarding

One user onboarding system is designed both to ensure users are fully educated on the functionalities of the system and to collect the necessary information and system permissions to allow them to use social networking services properly.

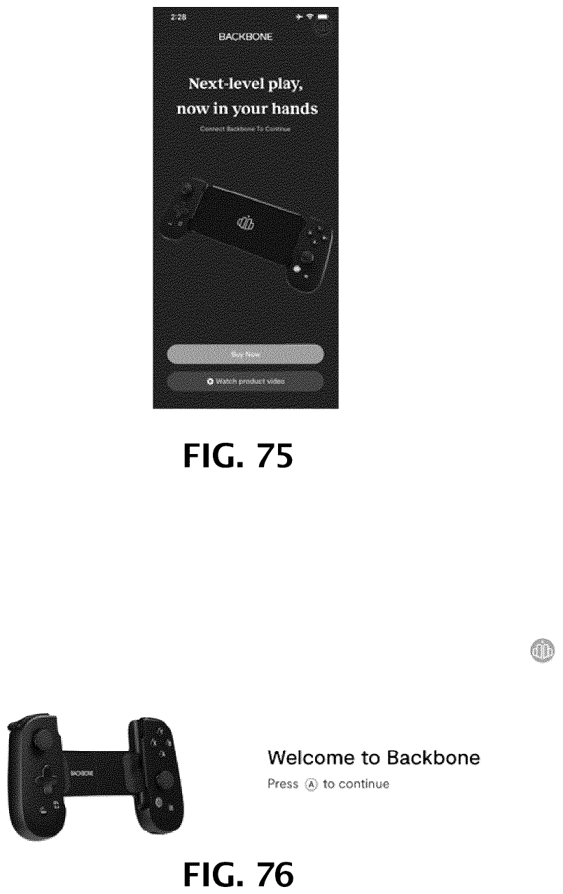

When users first launch the app, if they do not connect the accessory, they are presented with a screen explaining the benefits of purchasing the accessory via a product video, as well as a call to action to purchase the accessory via an e-commerce portal (see the Welcome Screen in FIG. 75). Once the application detects that the accessory is connected, it transitions to the screen shot shown in FIG. 76. The unit on the left in that screen shot is a three-dimensional render of the accessory, which animates into view and then repeatedly swivels and bounces. This animation occurs by stitching the starting animation with a video that can be looped, creating a seamless infinite looping transition. Both videos are encoded using HEVC to enable transparency.

Users can authenticate themselves into the service using one of two identity providers: Sign in with Apple, or Google Authentication. When using Sign in with Apple, authentication can take place by validating the user-provided authorization code against the provider's server, which then returns claims about the user's identity that are used to prefill the user's profile information. When using Google's authentication flow, the application instead provides the service an identity claim (in the form of a JSON Web Token) from the identity provider, which the service then verifies using RSA public key encryption.

In both cases, once the user's identity is verified, the service issues a persistent access and refresh token in accordance with OAuth 2.0.

User Phone Number Verification

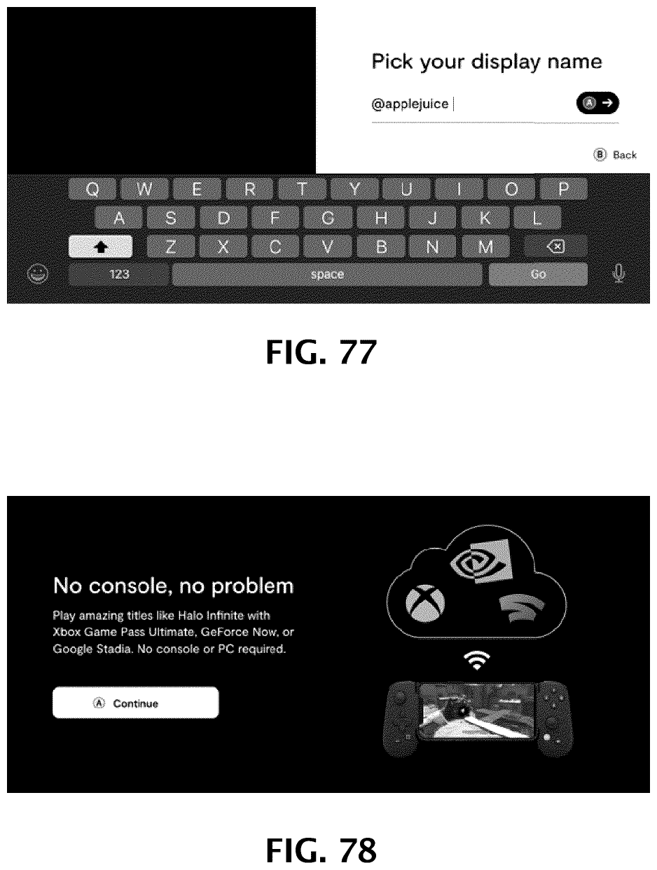

One onboarding process verifies the user has a phone number, and the screen shot in FIG. 77 allows the user to input a user name.

Cloud Gaming Education

In order to educate the user that the platform operating service and controller allows for frictionless gameplay on mobile devices, it may surface to the user the fact that they can interact with cloud gaming/streaming services with inputs from the mobile gaming controller, and from the platform operating service. It may also educate the user that use of these services do not require the presence of a non-mobile device, such as a specialized gaming console (e.g. an Xbox) or a personal desktop/laptop, as shown in the screen shot in FIG. 78.

Subscription Education

Users may have difficulty in discovering and accessing features provided by the platform operating service, complicating their ability to receive benefit and value from the service. This can be especially important when the platform operating service may be an embedded experience within the device operating system. To ensure users can find and understand the value of the platform operating service, regardless of whether they have access to all or some aspects of the platform operating service, the software service button can be utilized to facilitate easy access to some interfaces of the platform operating service, including functionality that educates and surfaces to users the features the platform operating service provides.

### Example Implementation

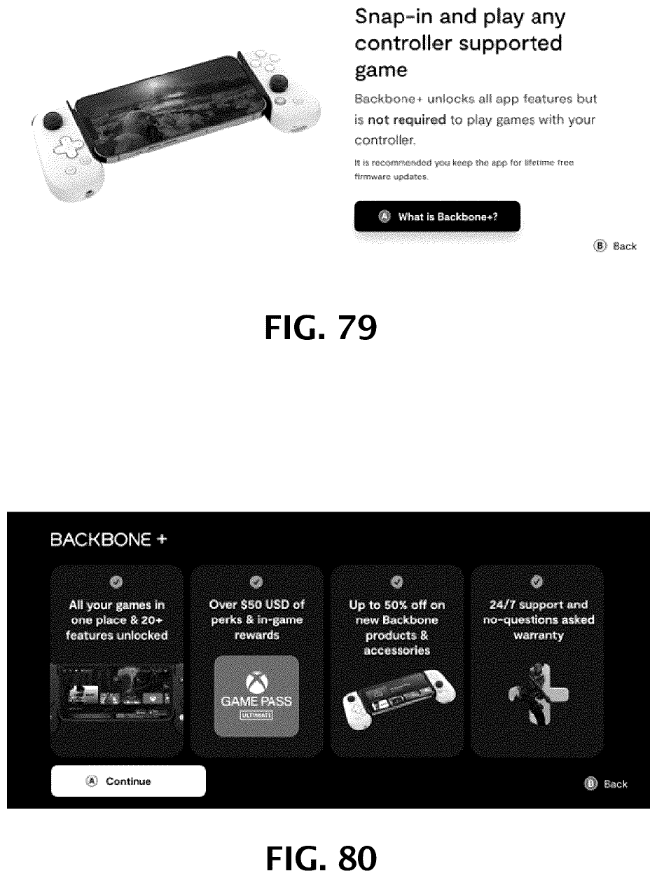

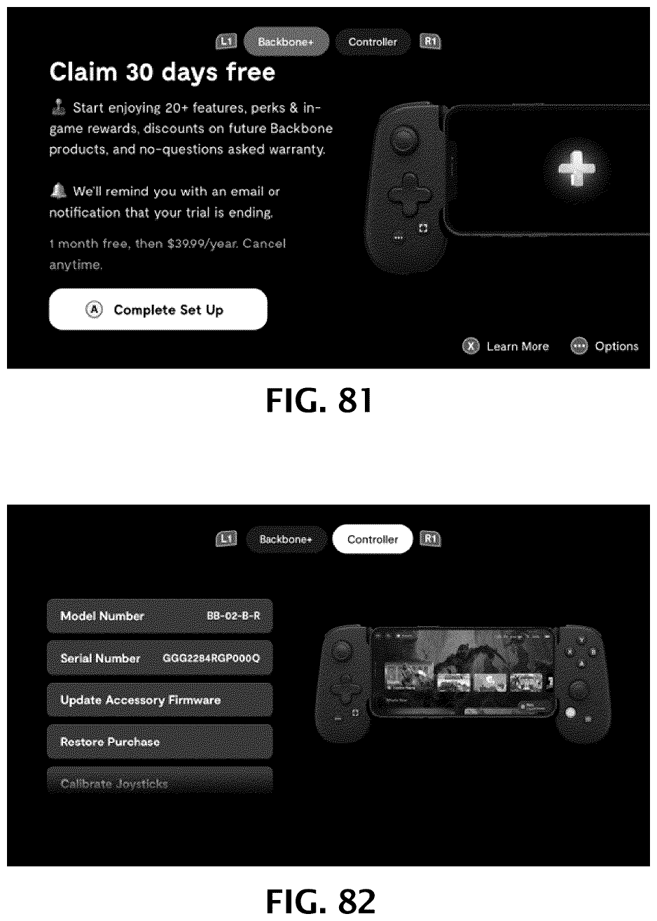

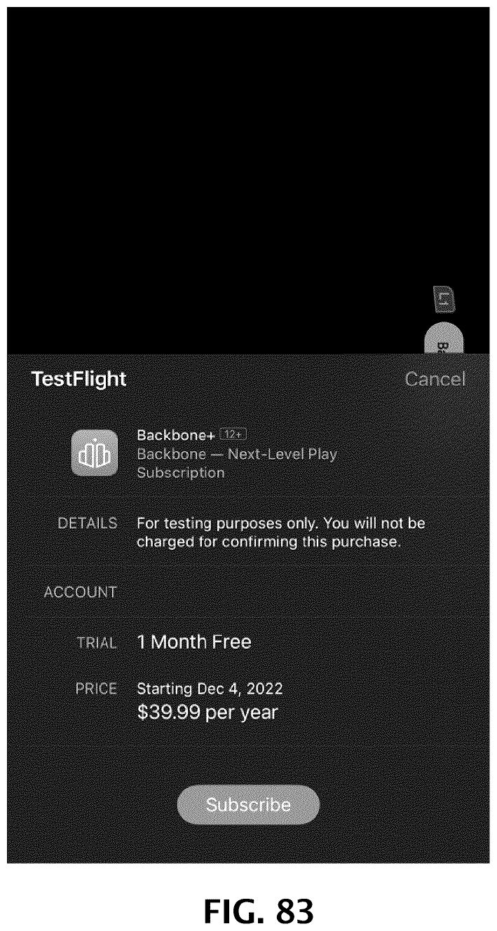

In some embodiments, some aspects of the platform operating service may require additional purchase or purchases, such as a subscription. Users may be educated about the benefits of these aspects from within the platform operating service application and/or prompted to purchase or subscribe to such features (see FIGS. 79-83).

In certain embodiments, the launching the platform operating service application could show user interfaces designed to educate users about the benefits of the platform operating service, either immediately or after the user interacts with the platform operating service for a period of time. Users can be provided with easy access to these explanations, for example, by pressing the software service button to or launching the platform operating service application through the device operating system. This can simplify the user's access to learning about the benefits of the platform operating system, which could otherwise only be accessible through other launch interfaces, such as the default launch functionality included in the device operating system.

If the user proceeds with the purchase or subscription, the software service button can be pressed to open an alternative screen, such as the Integrated Dashboard, or can show a user-configurable interface on press. This can allow the user to access the benefits of the platform operating service, especially the aspects thereof that may require additional purchase, without needing to use other, potentially more difficult to use, interfaces provided by, for example, the device operating system.

In other embodiments, the application can show these interfaces during the user setup process as well. This can ensure the user is given multiple opportunities to understand the benefits of the platform operating service.

Mobile Game Controller Physical Accessory Integration

An important aspect of the system experience is ensuring broad mobile device, mobile device protective case, and/or other physical accessory compatibility, namely enabling/improving fitment with mobile devices that have distinct dimensions, interfaces and device attributes as well as allowing the product to be used with a mobile device both coupled with and without protective cases.

In the past, the physical fitment of the phone in the mobile game controller is not a key consideration of the user experience, leading to device obsolescence given the rapid cadence of mobile device development and user confusion. From an experience point of view fitment can mean more than just baseline compatibility; fitment is especially important because, in order for the system to feel like a dedicated gaming host device, the mobile device and the mobile game controller are ideally rigidly coupled in one or more primary axes so that there is minimal flexion or play of the mobile device within the mobile game controller so as to enable immersive gameplay and provide a premium feel typically embodied in consumer electronics through stiff enclosures. In embodiments that involve some type of physical constraint (e.g. docking with Lightning interface or USB-C) or magnetic attach solution, the phone may tilt or translate undesirably, stressing the connector or magnetic attachment module. Additional risks include insufficient magnet strength due to tilt or translation misalignment due to the use of an incompatible phone case or an incompatible phone lacking a magnetic attach subsystem.

In some art in mobile device-based VR, the user friction of having to remove a mobile device case in order to use mobile device-based VR products has had a harmful impact on long-term user retention.

The following proposes a unique solution, specific to a mobile game controller system, to allow mobile game controller devices to improve fitment and physical interface compatibility with a multitude of mobile devices and mobile device cases or accessories by taking advantage of the integrated platform operating service and platform cloud service.

In this system, during the product or app setup flow, or when a mobile device is connected to the mobile game controller, the mobile device/tablet model, product SKU number, and device sensor data (e.g., accelerometer and camera data) from the mobile device as well as the mobile game controller can be sent to and processed by the platform operating service to trigger a specific on-screen interaction within the application intended to suggest ways the user can improve the physical fitment and coupling of devices by adjusting the phone or to intelligently recommend a compatible accessory. The recommended accessory can be an adapter used to enable or improve fitment or a protective mobile device case specific to a mobile device model that can be kept on the mobile device while the mobile game controller device is in use. Further, the on-screen interface can allow the user to then checkout and place an order for the relevant accessory if they do not already have it with the recommended accessory SKUs pre-populated based on the aforementioned telemetry (e.g., phone model, device SKU, accelerometer data). If the user's account information is known, the accessory checkout experience can also be delivered via email, text message, or through in-app means.

In certain embodiments, when a user connects a mobile device p that does not meet the product's fitment criteria to a mobile game controller device with SKU s, the platform operating service can request that the application provide on screen cues to suggest an accessory or physical mobile device placement that enables or enhances fitment. This prevents the user from having to make an independent, subjective judgment call about the perceived quality of the fitment, or rely solely on physically printed instructions that may lead to ambiguity or confusion.

For example, if an iPhone or Android phone is undesirably tilted, translated and/or misaligned in the product, causing shear or axial force on a Lightning, USB-C or other physical connector, the application can leverage mobile accelerometer data to provide on screen cues that indicate the mobile device is not level and can suggest using an alternate accessory that allows the phone to sit closer to level. In one embodiment, adapter inserts can be used in order to allow for phones of various sizes to fit into the smart mobile game controller device.

Further, in the event that the phone screen, phone camera systems, ports, speakers, or microphones are occluded due to the to the nature of the fitment of the mobile device p, the corresponding sensor data can be sent to the server, or audio test tones can be played and sent to the server. The server and application can interpret this data and can then inform the user via on screen cues that there is a fitment issue and suggest an adapter or accessory that would address it.

In certain embodiments, when such a mobile device p is connected, another possible concern is that the adapter or other necessary accessory is not coupled with the device at point of sale or is otherwise difficult to obtain. In some embodiments, the application can intelligently recommend a specific adapter or accessory SKU s′ based on the modes of data described above and further provide a checkout flow to allow the user to purchase the relevant accessory. For example, a new iPhone model is released after the introduction of a mobile game controller that is otherwise physically incompatible without the usage of an adapter. Alternatively, suppose that the user connects a phone for which they do not have an adapter that would enable or improve fitment. Leveraging the modes of data described above, the correct adapter can automatically be selected and encoded in the checkout URL, allowing the user to purchase in the app or via the web through the mobile browser. The user can then, in a single action, order an adapter SKU s′ that allows a mobile game controller device SKU s to have optimal fitment with a specific mobile device model p. This idea can be pursued to provide a scalable fitment solution across a large sample space of potential phone models, mobile game controllers and accessories. In one embodiment, physical adapters can be automatically manufactured as needed through 3D printing, additive manufacturing or subtractive manufacturing and sent to the user, possibly through automated ordering and delivery systems. In another embodiment, already stockpiled adapters can be automatically ordered and shipped to the user (“drop shipped”) directly from the manufacturer or warehouse, eliminating the need for human customer service agents.

In some embodiments, prior user analytics from the platform operating service can be used to determine if a user owns a mobile game controller SKU s. In this case, the user can then be prompted as soon as it is detected that a user has installed the application on the mobile device p. The converse is also true. Which is to say, the modes of data described above do not have to be processed synchronously in order to recommend an adapter accessory.

In some embodiments, the user's subscription status or the distribution channel through which the device was purchased can inform the price and distribution method of the accessory. For example, a user may purchase a mobile game controller device as described here that comes with a compatible phone case; however, the compatible phone case may not be offered at point of sale due to the large number of potential phone models and cases. Rather, when the user sets up the device or connects their phone, using the combination of the SKU s, mobile device p, and/or the user account data, the server and application can pre-populate a checkout flow for a mobile device case c compatible with both mobile game controller SKU s and detected mobile device p. Therefore, the user can have a method that allows them to purchase or redeem the mobile device in a single action. The checkout link can also be a function of the channel through which the device was originally purchased.

In some embodiments, the same implementation can also apply to recommend accessories for mobile game controllers or mobile devices such as carrying cases, battery pack, and more.

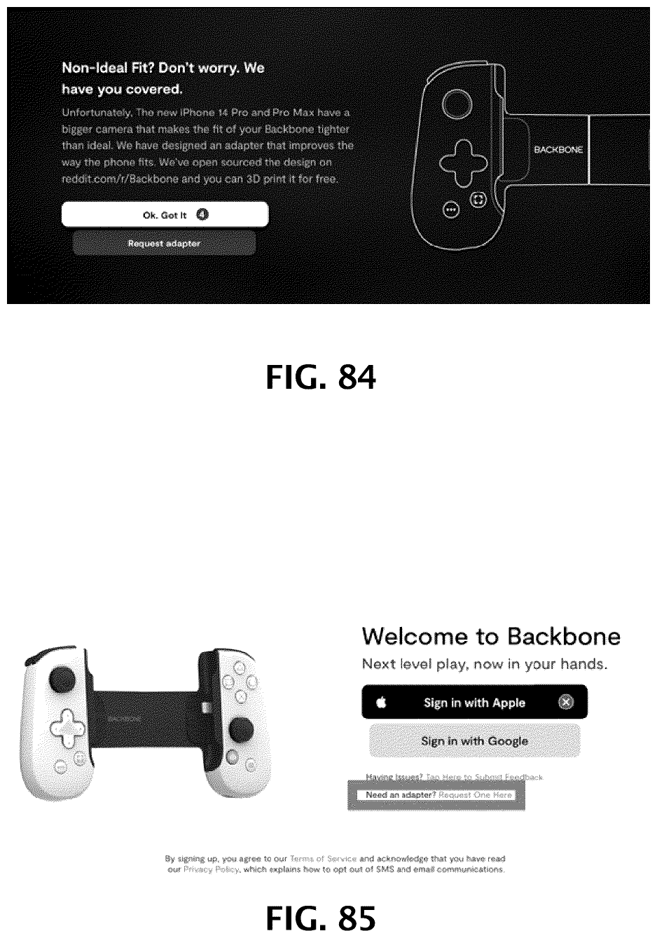

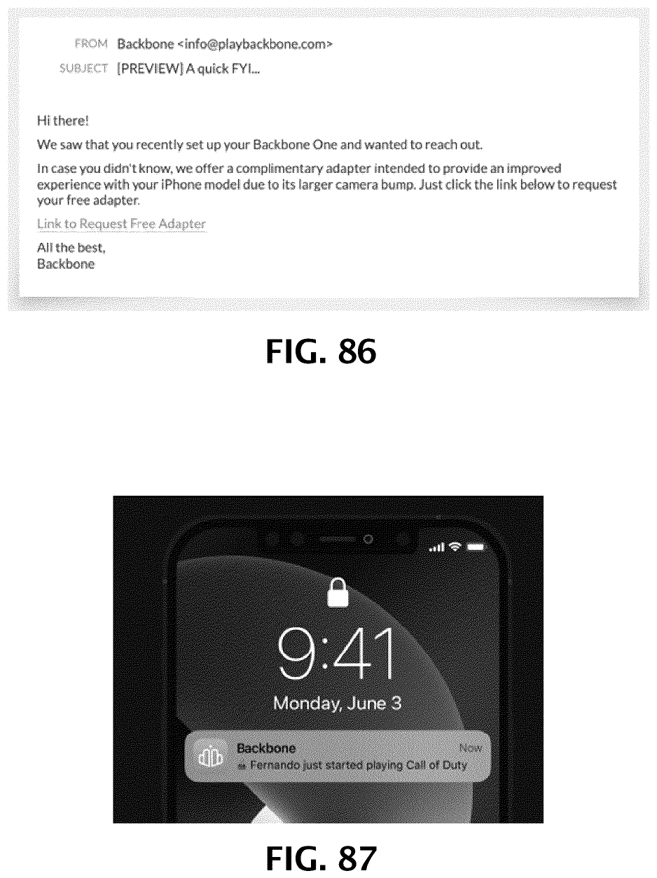

FIGS. 84-86 are screen shots that relate to the above embodiments.

Community and Social

In the past, many rich social experiences around gameplay were based around users' consoles and computing devices thought to be powerful enough for rich gameplay. The following describes a set of systems that ensure users can have a rich social experience on a much wider range of computing devices and operating services.

Real-Time Sharing of Activity State Performed on the Gameplay Device

In some embodiments, the activities performed by users on the gameplay device can be shared with other users, for example, with the user's friends on a social network, and this activity can be shared in real-time. Users can see various presence states for other users, for example, what games their friends are playing, whether they are currently in an audio chat experience, whether they are leveraging livestreaming or screen sharing functionalities, and whether they are available to engage in synchronous gameplay experiences. Users can be notified by the computing device about changes to this status and can be prompted to engage in social experiences with other users (see FIG. 87).

The following is an example of a user journey. First, the user performs one of a number of actions that can trigger a change to their activity status. This can include, but is not limited to, connecting a mobile gameplay controller to their computing device, launching the platform operating service application, launching a game from the integrated dashboard, entering or leaving an audio chat, beginning or ending sharing their screen in an audio chat, beginning or ending a live stream, and entering a period of inactivity by not providing input to the game controller for a period of time. Second, other users receive notifications about changes to the user's activity status. Users viewing the platform operating service can see the user's activity status update in real time.

### Example Implementation

In certain embodiments, the platform operating service application can observe a number of signals that represent different aspects of user activity, including, but not limited to, whether the application is active, whether the mobile game controller is connected to the computing device, the time of the last input the user made to the mobile game controller, whether the user is engaging in an audio chat, and if so, which one, the content the platform operating service has detected, whether the platform operating service application believes the user is playing any content, and whether the user is sharing a live stream, or sharing their screen through an audio chat. On update of any of these signals, the application can transmit the state change to the cloud service.

In certain embodiments, the cloud service can receive the transmitted state change and update its understanding of the user's status. The cloud service can aggregate the state of multiple gameplay devices belonging to the same user to present a complete understanding of the user's status, and can transmit this understanding to other gameplay devices in real time. Applications can use the platform operating service server's transmitted understanding to render the state information into a human-readable presentation of the user's status. Further, the platform operating service can send notifications to the user through a number of different media to prompt the users to engage with whose state changed, or other related users; for example, the platform operating service can respond to a user who becomes active and starts playing a game by prompting other users to play the same game, or the system can respond to a user who starts broadcasting a live stream by prompting other users to view the live stream.

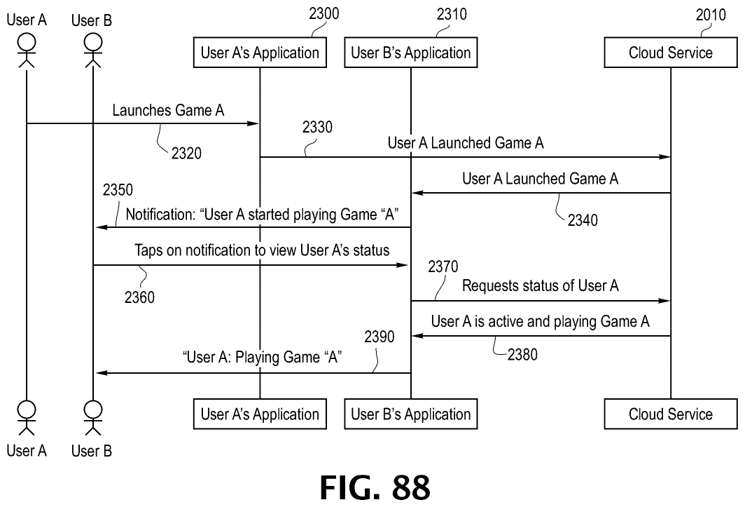

As shown in the flow diagram in FIG. 88, when User A launches Game A (act 2320), User A's application 2300 sends a notification to the cloud service 2010 (act 2330). The cloud service 2010 then notifies User B's application 2310 (act 2340), which notifies User B (act 2350). User B then taps on the notification to view User A's status (act 2360). In response, User B's application 2310 sends a request for User A's status to the cloud service 2010 (act 2370). The cloud service 2010 responds by informing User B's application 2310 that User A is active and is playing Game A (act 2380). User B's application 2310 the sends a notification to User B (act 2390).

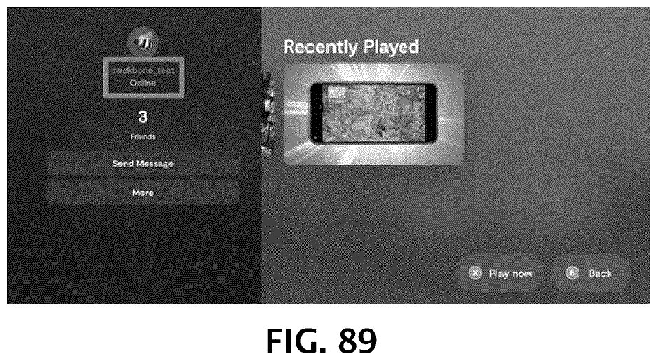

FIG. 89 is a screen shot showing an example of human readable presence indicator.

In other embodiments, the platform operating service application can observe different sets of signals, or transmit state information on a different schedule, for example, on a fixed interval to the platform operating service. Similarly, other embodiments could include the platform operating service transmitting the state change in other intervals, or only transmitting its understanding of user state upon request. Further, other embodiments could include the transmission of user activity state between computing devices directly, without the intervention of the platform operating service.

In other embodiments, the platform operating service can receive updated state information from sources besides the platform operating service application. For example, the platform operating service can receive information from external gameplay platforms about the user's activity status and/or what games a user is currently playing or has played recently. Such an embodiment could be enabled by leveraging the Account Linking functionality mentioned above.

As noted above, this description discloses, among other things, various example systems, methods, apparatus, and articles of manufacture including, among other components, firmware and/or software executed on hardware. It is also understood that such examples are merely illustrative and should not be considered as limiting.

What is claimed is:

1. A method comprising:
performing in a game controller comprising a primary port, a secondary port, and a non-volatile memory storing a plurality of game controller profiles:
using one of the plurality of game controller profiles to enable use of the game controller by a first computing device connected with the primary port;
receiving a selection of a different one of the plurality of game controller profiles; and
using the selected different one of the plurality of game controller profiles to enable use of the game controller by a second computing device connected with the secondary port.

2. The method of claim 1, wherein the selection is received from a user interaction with the first computing device.

3. The method of claim 1, wherein the selection is received from a position of a user-movable switch on the game controller.

4. The method of claim 1, wherein the selection is received from an identification of the second computing device, wherein the identification is received from the second computing device via the secondary port.

5. The method of claim 1, further comprising:
receiving an update to the plurality of game controller profiles stored in the non-volatile memory in the game controller.

6. The method of claim 1, further comprising:
causing an output of a visual indicator of the game controller to change in response to the game controller being used with the second computing device.

7. The method of claim 1, further comprising:
receiving analytics data from the second computing device regarding use of the game controller with the second computing device; and
sending the analytics data to the first computing device for local or remote analysis.

8. The method of claim 1, wherein the secondary port is configured to use a USB protocol.

9. The method of claim 1, wherein the secondary port is configured to pass data and power.

10. A game controller comprising:
a first port;
a second port;
one or more processors;
a non-transitory computer-readable medium; and
program instructions stored on the non-transitory computer-readable medium that, when executed by the one or more processors, cause the one or more processors to perform functions comprising:
in response to a first computing device being connected with the first port, sending a first set of descriptors to the first computing device to enable the first computing device to use the game controller; and
in response to a second computing device being connected with the second port, sending a second set of descriptors to the second computing device to enable the second computing device to use the game controller.

11. The game controller of claim 10, further comprising:
a transceiver used at least by the second port.

12. The game controller of claim 11, wherein the program instructions, when executed by the one or more processors, further cause the one or more processors to perform functions comprising:
monitoring a state of differential data pins of the second port to detect whether the second computing device is connected with the second port; and
enabling the transceiver in response to detecting that the second computing device is connected with the second port.

13. The game controller of claim 10, wherein the first and second set of descriptors comprise different human interface device (HID) descriptors.

14. The game controller of claim 10, wherein the first and second set of descriptors comprise different user input device mappings.

15. The game controller of claim 10, wherein the first and second set of descriptors comprise different audio settings.

16. The game controller of claim 10, wherein the first and second set of descriptors comprise different authentication protocols.

17. A non-transitory computer-readable medium storing program instructions that, when executed by one or more processors of a game controller comprising primary and secondary ports, cause the one or more processors to perform functions comprising:
dynamically changing a configuration of the game controller from a first configuration that allows the game controller to be used by a first computing device connected with the primary port to a second configuration that allows the game controller to be used by a second computing device connected with the secondary port.

18. The non-transitory computer-readable medium of claim 17, wherein the configuration of the game controller is dynamically changed in response to a user input.

19. The non-transitory computer-readable medium of claim 17, wherein the configuration of the game controller is dynamically changed automatically in response to on an identification of the second computing device.

20. The non-transitory computer-readable medium of claim 17, wherein the first and second configurations comprise different human interface device (HID) descriptors, user input device mappings, audio settings, and/or authentication protocols.

21. A method comprising:
performing in a game controller comprising a port and a non-volatile memory storing a plurality of game controller profiles:
using one of the plurality of game controller profiles to enable use of the game controller by a first computing device connected with the port;
receiving a selection of a different one of the plurality of game controller profiles; and
using the selected different one of the plurality of game controller profiles to enable use of the game controller by a second computing device later connected with the port.

22. The method of claim 21, wherein the selection is received from a user interaction with the first computing device.

23. The method of claim 21, wherein the selection is received from a position of a user-movable switch on the game controller.

24. The method of claim 21, wherein the selection is received from an identification of the second computing device, wherein the identification is received from the second computing device via the port.

25. The method of claim 21, further comprising:
receiving an update to the plurality of game controller profiles stored in the non-volatile memory in the game controller.

26. The method of claim 21, further comprising:
causing an output of a visual indicator of the game controller to change in response to the game controller being used with the second computing device.

27. The method of claim 21, further comprising:
receiving analytics data from the second computing device regarding use of the game controller with the second computing device; and
sending the analytics data to the first computing device for local or remote analysis.

28. The method of claim 21, wherein the port is configured to use a USB protocol.

29. The method of claim 21, wherein the port is configured to pass data and power.
